(19) United States
(12) Patent Application Publication
(10) Pub. No.: US 2017/0324274 A1
(43) Pub. Date: Nov. 9, 2017

(54) Power Monitoring and Control System and Method

(71) Applicant: Minesh Bhakta, Tempe, AZ (US)

(72) Inventor: Minesh Bhakta, Tempe, AZ (US)

(21) Appl. No.: 15/658,915

(22) Filed: Jul. 25, 2017

Related U.S. Application Data
(63) Continuation-in-part of application No. 14/922,978, filed on Oct. 26, 2015.

(51) Int. Cl. H02J 13/00; G05B 15/02; H04L 29/08

(52) U.S. Cl. CPC H02J 13/0017; G05B 15/02; H04L 67/10

(57) ABSTRACT

A system, comprising a metering system, and a load sensor which provides the metering system with a performance parameter corresponding to the operation of the electrical load. The metering system provides a data signal and transmits a data packet via a two-way energy management data packet network, wherein the data signal includes information regarding the performance parameter. The data signal can include environmental sense information corresponding to the environment proximate to the electrical load. The energy management data packet network carries a control signal back to t provide active control over the operation of the electrical load for energy management purposes.

### CROSS-REFERENCE TO RELATED APPLICATIONS

This application is a continuation-in-part of, and claims the benefit of, U.S. patent application Ser. No. 14/922,978, filed on Oct. 26, 2015, the contents of which are incorporated by reference as though fully set forth herein.

### BACKGROUND OF THE INVENTION

### Field of the Invention

This invention relates generally to power regulation and, more particularly, to providing information regarding the operation of an electrical load.

### Description of the Related Art

Energy monitoring and control systems are widely used to provide centralized monitoring and control of an electrical load in an electrical system. The electrical load can be of many different types, such as heating, cooling, appliances and lighting devices. It is desirable to monitor and control the electrical load to monitor and control the energy usage by the electrical load. More information regarding such systems and electrical loads is provided in the Backgrounds of the above-identified related applications. Other references to note include U.S. Pat. Nos. 4,174.517, 4,418,333, 5,521,838, 5,563,455, 5,880.677, 5.978,569 and 7,379,997, as well as U.S. Patent Application Nos. 20060120008 and 20080031026.

It is desirable to provide a way to better control the operation of the electrical load. For example, it is also desirable to control the operation of the electrical load by sending a command to it and, in response, receive desired operating parameters. It is also desirable to control the operation of the electrical load in response to a signal from a sensor.

### BRIEF SUMMARY OF THE INVENTION

The present invention involves a system which provides power regulation and information regarding the operation of an electrical load. The invention will be best understood from the following description when read in conjunction with the accompanying drawings.

### BRIEF DESCRIPTION OF THE DRAWINGS

It should be noted that like reference characters arc used throughout the several views of the Drawings.

FIG. 1 is a block diagram of an energy management system, which includes a modular card.

FIG. 2a is a diagram of a data packet, which corresponds to one example of the data packet S_{DataPacket} of FIG. 1.

FIG. 2b is a diagram of another example of a data packet, which corresponds to the data packet S_{DataPacket} of FIG. 1.

FIG. 2c is a diagram of another example of a data packet, which corresponds to the data packet S_{DataPacket} of FIG. 1.

FIG. 2d is a diagram of another example of a data packet, which corresponds to the data packet S_{DataPacket} of FIG. 1.

FIG. 2e is a diagram of another example of a data packet, which corresponds to the data packet S_{DataPacket} of FIG. 1.

FIG. 2f is a diagram of another example of a data packet, which corresponds to the data packet S_{DataPacket} of FIG. 1.

FIG. 3 is a block diagram of another embodiment of an energy management system.

FIG. 4 is a block diagram of a modular card 115 of FIG. 1 in communication with a plurality of load sensors and a plurality of environmental sensors.

FIG. 5 is a perspective view of an energy management system, which includes an analog metering system.

FIG. 6a is a perspective view of one embodiment of the metering system, which includes an enclosure and circuit board.

FIG. 6b is a side view of one embodiment of a modular card, which includes a circuit board.

FIG. 7a is a block diagram of an analog load controller, which includes a metering system, modular card, and an analog controller.

FIG. 7b is a block diagram of a digital load controller, which includes a metering system, modular card, and a digital controller.

FIG. 8 is a perspective view of an energy management system, which includes a digital metering system.

FIGS. 9a and 9b are is a perspective and top views, respectively, of another embodiment of a metering system.

FIG. 10 is a block diagram of an energy management system, which includes a metering system and modular card for an analog system.

FIG. 11 is a block diagram of an energy management system, which includes a modular card, sensor port, and an analog controller.

FIG. 12 is a block diagram of one embodiment of a metering panel system, which includes a metering system, modular card, and an analog load controller.

FIG. 13 is a block diagram of one embodiment of a metering panel system, which includes a metering system, modular card, and a digital bad controller.

FIG. 14 is a block diagram of another embodiment of a metering panel system.

FIG. 15 is a block diagram of a further embodiment of a metering panel system.

### DETAILED DESCRIPTION OF THE INVENTION

Disclosed herein are several energy management systems which monitor and/or control the operation of one or more electrical loads. This is desirable because, for many different reasons, the operation of an electrical load is expensive. One reason the operation is expensive is because electrical power is expensive and the general trend is for it to increase in cost. Another reason the operation is expensive is because the electrical load has a certain lifetime after which it fails and needs to be fixed or replaced. The lifetime tends to decrease the more the electrical load is used, so in some instances, it is desirable to turn it off when not needed so its lifetime will not decrease as rapidly.

In some embodiments, the performance and/or efficiency of the electrical load is monitored by the energy management system, which is desirable because the performance typically changes with time as the electrical load's lifetime decreases. Hence, by monitoring the electrical load's performance and/or efficiency, it can be determined whether or not it is approaching the end of its useful lifetime. This can be done because electrical loads are generally manufactured to operate within a particular range of power consumption, voltage (V), current (A), and temperature. An indication that the electrical load is reaching the end of its useful lifetime and is about to fail occurs when the electrical load is operating outside one or more of these ranges. Further, newer and more efficient electrical loads are typically being developed, so the energy management system can be used to determine whether it is more cost effective to replace an old electrical load with a newer and more efficient electrical load.

The energy management system is useful in many different settings. For example, it can be used at home, in an office, or another setting to monitor and control the operation of electrical loads typically used in these places. The electrical load can be any type of electrical load, such as an appliance, television, computer, air conditioner, lamp, hair drier, refrigerator, etc. which are generally powered by an electrical outlet. The electrical load can also include wireless sensors, such as a motion sensor, smoke detector, temperature sensor, air pressure/quality sensor, and a switch sensor.

In one particular example, the energy management system is used to monitor and control the electrical load in a room of a hotel. If the room is currently unoccupied, then the energy management system can turn the electrical load in this room off to reduce operating costs. If the room is going to be occupied, then the electrical load in the room can be provided with power by the energy management system so they can be used by the occupants. If the room is currently being occupied, then the energy management system can monitor and/or control the operation of the electrical load.

In another example, the energy management system is used to determine the amount of power consumed over a particular period of time by the electrical load in a commercial building, residential building, or another type of building. This is desirable because sometimes there arc two rates for electrical power, a low rate and a high rate. In some instances, the low rate is paid when the total power usage is below a predetermined threshold power value and the high rate is paid when the total power usage is above the predetermined threshold power value. Since it is desirable for the consumer to pay the lower rate, the energy management system can be used to determine the total power usage so if can be compared to the predetermined threshold power value. In this way, the consumer will know how much power they can use before they go above the threshold power value and have to pay the higher rate.

It should be noted that, in the embodiments disclosed herein, the energy management system generally includes one or more electrical devices coupled together. The electrical devices can be of many different types, such as passive and active electrical devices. Passive electrical devices include resistors, capacitors, inductors, and connectors, among others. Active electrical devices include diodes, transistors, power supplies, transceivers, controllers, and processor, among others. The electrical devices can be coupled together in many different ways. Typically, the electrical devices are mounted to a circuit board, such as a printed circuit board (PCB), wherein the printed circuit board includes one or more conductive lines that extend between the electrical devices so that an electrical signal can flow therebetween. The conductive lines connect the different electrical devices, and allow the electrical devices to communicate with each other. In this way, the electrical devices are coupled together.

FIG. 1 is a block diagram of an energy management system 100a. In this embodiment, the energy management system 100a includes a modular card 115. In operation, the modular card 115 provides a data packet, S_{DataPacket}, in response to receiving a control signal S_{Control}, wherein the data packet S_{DataPacket} includes information corresponding to a load sense signal, S_{LoadSense}, and an environment sense signal, S_{EnvSense}. In operation, (he modular card 115 provides a relay signal S_{Relay} in response to receiving the control signal S_{Control}. As will be discussed in more detail below, the relay signal S_{Relay} is provided to a relay (not shown), wherein the relay is coupled to an electrical load. The operation of the electrical load is controlled in response to moving the relay between ON and OFF conditions. In some embodiments. the electrical load operates in response to the relay being in the ON condition, and the electrical load is restricted from operating in response to the relay being in the OFF condition.

As will be discussed in more detail below, the load sense signal includes information corresponding to the operation of an electrical load. The information corresponding to the operation of the electrical load can be of many different types, such as the temperature of operation, power consumption, power consumption as a function of time, voltage, current, power factor, and/or frequency of operation of the electrical load. The information of the load sense signal, S_{LoadSense}, can correspond to a performance parameter discussed in U.S. application Ser. No. No. 14/922,978, as well as U.S. Pat. Nos. 7,555,365, 8,095,243, and 9,172,275, which are referenced above. Hence, the performance parameter can correspond to a voltage, current, frequency, power, and temperature of the electrical load.

As will be discussed in more detail below, the environment sense signal S_{EnvSense} includes information corresponding to the operation of an environmental sensor. The information corresponding to the operation of the environmental sensor can be of many different types, such as the temperature and humidity, among others, it should be noted that the information provided by the environmental sensor corresponds to the environment proximate to the electrical load. The information corresponding to the operation of the environmental sensor will be discussed in more detail below.

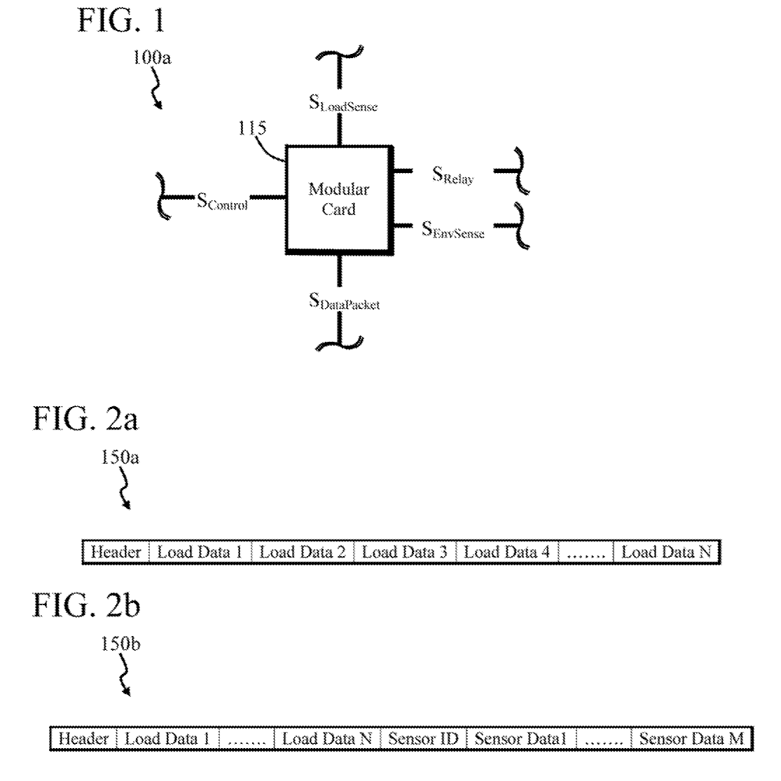

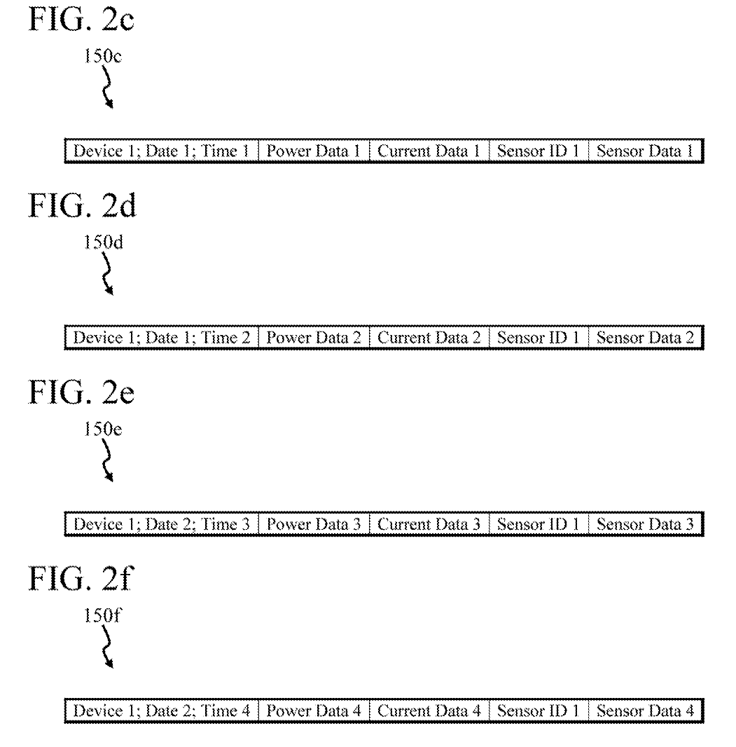

FIG. 2a is a diagram of a data packet 150a, which corresponds to one example of the data packet S_{DataPacket} of FIG. 1. The data packets disclosed herein can be of many different types. In some embodiments, the data packets include a finite amount of information, such as a predetermined number of bits. Data packets are useful because they have a smaller bandwidth than data signals. However, it should be noted that data signals can be used with the invention disclosed herein. The other signals discussed herein, such as the control and relay signals, can also be data packets, which have a smaller bandwidth. Some embodiments of the system disclosed herein are capable of flowing data packets between about five hundred times per second to once per second. The rate at which the data packets How can be chosen by the user. For example, the system can send data packets once per minute and once per hour, if desired.

In this embodiment, the data packet 150a includes a Header portion. The Header portion can include many different types of information, such as an Identification Number (ID) corresponding to the electrical load. As will be discussed in more detail below, the energy management system can include a plurality of electrical loads, so that each electrical load has a unique ID. In this way, each electrical load can be individually identified, monitored, and controlled. The header portion can also include date information, such as the year, month, and day that corresponds to the data portion. The information of the data portion for desired dates can be compared. The header portion can also include time information, such as the hour, minute, and second that corresponds to the data portion. In this way, the information of the data portion for desired times can be compared.

In this embodiment, the data packet 150a includes a plurality of data portions, wherein the data portions are denoted as Load Data 1, Load Data 2, . . . load Data N, wherein N is a positive number greater than or equal to one. The plurality of data portions are included with the load sense signal. S_{LoadSense}. The plurality of data portions can include many different types of information, such as the information mentioned above with FIG. 1. For example, in one situation. Load Data 1, Load Data 2, and Load Data 3 correspond to the current, voltage, and power of the electrical device. In another situation. Load Data 1. Load Data 2, and Load Data 3 correspond to the frequency of operation, power factor, and temperature of the electrical device. It should be noted that the form of the data packet, such as data packet 150a, is adjustable in response to adjusting control signal S_{Control}, as will be discussed in more detail below. It should be noted that the power, current, and sensor data corresponds to data at the time and date indicated, such as Date 1 and Time 1.

FIG. 2b is a diagram of a data packet 150b, which corresponds to the data packet S_{DataPacket} of FIG. 1. In this embodiment, the data packet 150b includes the Header portion, and a plurality of data portions, as discussed above with FIG. 2a. In this embodiment however, the control signal S_{Control} has been adjusted so that the data portions include a sensor ID, which corresponds to a sensor that provides the environment sense signal S_{EnvSense}. As will be discussed in more detail below, the energy management system can include a plurality of sensors, so that each sensor has a unique ID. In this way, each sensor can be individually identified, monitored, and controlled.

The plurality of data portions can include many different types of information, such as the information mentioned above with FIGS. 1 and 2a. In this embodiment, the control signal S_{Control} has been adjusted so the plurality of data portions includes a plurality of sensor data portions, which are denoted as Sensor Data 1, Sensor Data 2, . . . , Data M, wherein M is a positive number greater than or equal to one. As discussed in more detail below, the sensor data can be of many different types, such as temperature data, and humidity data, among others. The sensor data can also correspond to an indication signal, such as a warning from a smoke detector, gas meter, humidity sensor, and motion sensor, among others.

FIG. 2c is a diagram of a data packet 150c, which corresponds to the data packet S_{DataPacket} of FIG. 1. In this embodiment, the data packet 150c includes a plurality of data portions, in this embodiment, the control signal S_{Control} has been adjusted so that the data portions include a Device 1 data portion, which includes a Date 1 and lime 1. The Device 1 data portion corresponds to an identification of a device, such as a load device. The identification of the device can correspond to a unique ID, such as an IP address. The Date 1 and Time 1 data portions correspond to the date and time it is desired to acquire information corresponding to the Device 1. The Date 1 and Time 1 data portions can correspond to predetermined dates and times, if desired. The predetermined dates and times can be periodic.

In this embodiment, the control signal S_{Control} includes data portions Power Data 1 and Current Data 1. The data portion Power Data 1 corresponds to the amount of power consumed by the Device 1, and the data portion Current Data 1 corresponds to the current flow through the Device 1.

In this embodiment, the control signal S_{Control} sensor data portions Sensor ID 1 and Sensor Data 1. The Sensor ID 1 data corresponds to an identification of the sensor. The identification of the sensor can correspond to a unique ID, such as an IP address. In this embodiment, the Sensor Data 1 portion corresponds to information of the environment sense signal S_{EnvSense}. The Sensor Data 1 portion can be of many different types, such as temperature data, and humidity data, among others. The sensor data can also correspond to an indication signal, such as a warning from a smoke detector, gas meter, humidity sensor, and motion sensor, among others. It should be noted that the Power Data 1, Current Data 1, and Sensor Data 1 correspond to data of Device 1 at Date 1 and Time 1.

FIG. 2d is a diagram of a data packet 150d, which corresponds to the data packet S_{DataPacket} of FIG. 1. In this embodiment, the data packet 150d includes a plurality of data portions. In this embodiment, the control signal S_{Control} has been adjusted so that the data portions include a Device 1 data portion, which includes a Date 1 and Time 2. The Device 1 data portion corresponds to an identification of a device, such as a load device. The identification of the device can correspond to a unique ID, such as an IP address. The Date 1 and Time 2 data portions correspond to the dale and lime it is desired to acquire information corresponding to the Device 1. The Date 1 and Time 2 data portions can correspond to predetermined dates and limes, if desired. The predetermined dates and times can be periodic. In general, the Time 1 and Time 2 data portions correspond to different times.

In this embodiment, the control signal S_{Control} includes data portions Power Data 2 and Current Data 2. The data portion Power Data 2 corresponds to the amount of power consumed by the Device 1, and the data portion Current Data 2 corresponds to the current flow through the Device 1.

In this embodiment, the control signal S_{Control} includes sensor data portions Sensor ID 1 and Sensor Data 2. The Sensor ID 2 data corresponds to an identification of the sensor. The identification of the sensor can correspond to a unique ID. such as an IP address. In this embodiment, the Sensor Data 2 portion corresponds to information of the environment sense signal S_{EnvSense}. The Sensor Data 2 portion can be of many different types, such as temperature data, and humidity data, among others. The sensor data can also correspond to an indication signal, such as a warning from a smoke detector, gas meter, humidity sensor, and motion sensor, among others. In this way, the data packet S_{DataPacket} corresponds to data portions at different times. It should lie noted that the Power Data 2, Current Data 2, and Sensor Data 2 correspond to data of Device 1 at Date 1 and Time 2.

FIG. 2e is a diagram of a data packet 150e, which corresponds to the data packet S_{DataPacket} of FIG. 1. In this embodiment, the data packet 150e includes a plurality of data portions. In this embodiment, the control signal S_{Control} has been adjusted so that the data portions include a Device 1 data portion, which includes a Date 2 and Time 3. The Device 1 data portion corresponds to an identification of a device, such as a load device. The identification of the device can correspond to a unique ID, such as an IP address. The Date 2 and Time 3 data portions correspond to the date and time it is desired to acquire information corresponding to the Device 1. The Date 2 and Time 3 data portions can correspond to predetermined dates and times, if desired. The predetermined dates and times can be periodic. In general, the Time 1, Time 2, and Time 3 data portions correspond to different times.

In this embodiment, the control signal S_{Control} includes data portions Power Data 3 and Current Data 3. The data portion Power Data 3 corresponds to the amount of power consumed by the Device 1, and the data portion Current Data 3 corresponds to the current flow through the Device 1.

In this embodiment, the control signal S_{Control} includes sensor data portions Sensor ID 1 and Sensor Data 3. The Sensor ID 3 data corresponds to an identification of the sensor. The identification of the sensor can correspond to a unique ID, such as an IP address. In this embodiment, the Sensor Data 3 portion corresponds to information of the environment sense signal S_{EnvSense}. The Sensor Data 3 portion can be of many different types, such as temperature data, and humidity data, among others. The sensor data can also correspond to an indication signal, such as a warning from a smoke detector, gas meter, humidity sensor, and motion sensor, among others. In this way, the data packet S_{DataPacket} corresponds to data portions at different times and different dates, it should be noted that the Power Data 3. Current Data 3. and Sensor Data 3 correspond to data of Device 1 at Date 2 and Time 3.

FIG. 2f is a diagram of a data packet 150f, which corresponds to the data packet S_{DataPacket} of FIG. 1. In this embodiment, the data packet 150f includes a plurality of data portions. In this embodiment, the control signal S_{Control} has been adjusted so that the data portions include a Device 1 data portion, which includes a Date 2 and Time 4. The Device 1 data portion corresponds to an identification of a device, such as a load device. The identification of the device can correspond to a unique ID. such as an IP address. The Date 2 and Time 4 data portions correspond to the date and time it is desired to acquire information corresponding to the Device 1. The Date 2 and Time 4 data portions can correspond to predetermined dates and times, if desired. The predetermined dates and times can be periodic. In general, the Time 1, Time 2, Time 3, and Time 4 data portions correspond to different times.

In this embodiment, the control signal S_{Control} includes data portions Power Data 4 and Current Data 4. The data portion Power Data 4 corresponds to the amount of power consumed by the Device 1, and the data portion Current Data 4 corresponds to the current flow through the Device 1.

In this embodiment, the control signal S_{Control} includes sensor data portions Sensor ID 1 and Sensor Data 4. The Sensor ID 4 data corresponds to an identification of the sensor. The identification of the sensor can correspond to a unique ID, such as an IP address. In this embodiment, the Sensor Data 4 portion corresponds to information of the environment sense signal S_{EnvSense}. The Sensor Data 4 portion can be of many different types, such as temperature data, and humidity data, among others. The sensor data can also correspond to an indication signal, such as a warning from a smoke detector, gas meter, humidity sensor, and motion sensor, among others. In this way, the data packet S_{DataPacket} corresponds to data portions at different times and different dates. It should be noted that the Power Data 4, Current Data 4, and Sensor Data 4 correspond to data of Device 1 at Date 2 and Time 4.

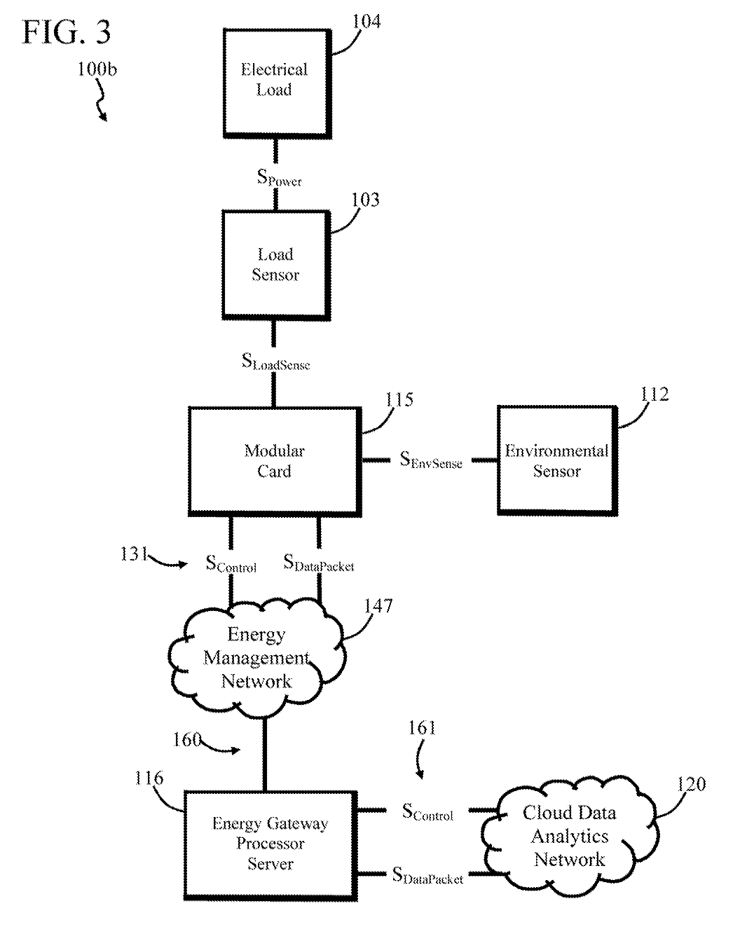

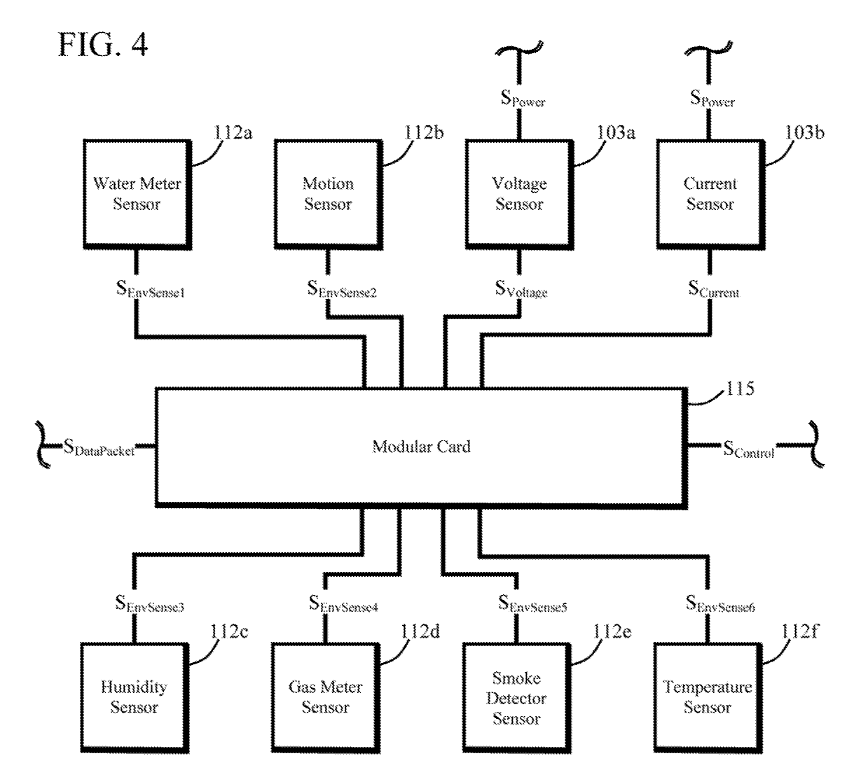

FIG. 3 is a block diagram of an energy management system 100b. In this embodiment, the energy management system 100b includes the modular card 115. More information regarding the modular card 115 is provided above with FIG. 1. In this embodiment, the energy management system 100b includes an environmental sensor 112 in communication with the modular card 115. The environmental sensor 112 can be of many different types, several of which are discussed with FIG. 4 below. The environmental sensor 112 determines environmental information proximate thereto, and provides the environmental sense signal S_{EnvSense} in response to the modular card 115. In this way. the environmental sensor 112 is in communication with the modular card 115. Sense signals are discussed above, such as with FIGS. 2a-2f.

In this embodiment, the energy management system 100b includes a load sensor 103 in communication with the modular card 115. A load sense signal, S_{LoadSense}, flows between the load sensor 103 and modular card 115. The load sensor 103 can be of many different types, as will be discussed in more detail below with FIG. 4. Load signals are discussed above, such as with FIGS. 2a-2f.

In this embodiment, the energy management system 100b includes art electrical load 104 in communication with the modular card through the load sensor 103. In general, the electrical load 104 operates in response to receiving a power signal S_{Power}. The electrical load 104 can be of many different types, such as an electrical device that is operated in response to receiving AC power. Examples of electrical devices include an air conditioner (AC unit), split air conditioner, television, pool pump, washer, dryer, stove, refrigerator, refrigerated display case, hot water heater, water pump, fountain, compressor, solar panel, light, computer, and power tool, among others. Loads, and data corresponding to loads, are discussed in more detail above with FIGS. 2a-2f. It should be noted that the electrical load 104 is typically operated by a load controller. The load controller can be digital and analog. An example of a digital load controller is a digital device, such as a computer and smart phone. An example of an analog load controller is a thermostat. A relay is typically included with the embodiments that include the analog load controller.

In operation, the load sensor 103 determines the information corresponding to the operation of the electrical load 104. In one embodiment, the load sensor 103 determines the information corresponding to the operation of the electrical load 104 from the power signal S_{Power}, and provides the load sense signal S_{LoadSense} in response to the modular card 115. The modular card 115 receives the load sense signal S_{LoadSense} and environmental sense signal S_{EnvSense} from the load sensor 103 and environmental sensor 112, respectively. The modular card 115 provides the data packet S_{DataPacket} in response to receiving the load sense signal S_{LoadSense} and environmental sense signal S_{EnvSense} as discussed above with FIG. 1.

In this embodiment, the energy management system 100b includes an energy management data packet network 147, which is in communication with the modular card 115 through a communication link 131. The energy management data packet network 147 can he in communication with the modular card 115 in many different ways. In some embodiments, the energy management data packet network 147 is in communication with the modular card 115 through a wired communication link, such as an Ethernet cable. In other embodiments, the energy management data packet network 147 is in communication with the modular card 115 through a wireless communication link, such as a wireless router. Hence, in the embodiments disclosed herein, a communication link 131 can be a wired communication link and a wireless communication link. It should be noted that the control signal S_{Control} and data packet S_{DataPacket} flow through the communication link 131.

In operation, the control signal S_{Control} is provided to the modular card 115 through the energy management data packet network 147 and communication link 131. In response, the load sensor 103 provides the desired load data to the modular card 115 through the load sense signal S_{Loadsense}. Further, in response, the environmental sensor 112 provides the desired environmental sensor data to the modular card 115 through the environmental sense signal S_{EnvSense}. In response to the control signal S_{Control} the modular card 115 provides the data packet S_{DataPacket}, with the desired information from the load sense signal S_{LoadSense} and the environmental sense signal S_{EnvSense} to the energy management data packet network 147 through the communication link 131. Examples of the data packets S_{DataPacket} are provided above with FIGS. 2a-2f.

In this embodiment, the energy management system 100b includes an energy gateway processor serer 116 in communication with the energy management data packet network 147 through a communication link 160. Further, the energy management system 100b includes a cloud data analytics network 120 in communication with the energy gateway processor server 116 through a communication link 161. It should be noted that the communication links 160 and 161 can be wired and/or wireless communication links.

In operation, the signals S_{Control} and/or S_{DataPacket} are flowed to the cloud data analytics network 120 through the communication links 160 and 161 and the energy gateway processor serve 116. In some situations, the cloud data analytics network 120 includes software that processes the signals S_{Control} and/or S_{DataPacket}. In some situations, the cloud data analytics network 120 includes software that displays the signals S_{Control} and/or S_{DataPacket}. The signals S_{Control} and/or S_{DataPacket} can be displayed in many different ways, such as in a graph.

FIG. 4 is a block diagram of the modular card 115 of FIG. 1 in communication with a plurality of load sensors and a plurality of environmental sensors. The plurality of load sensors can be of many different types. In this embodiment, the plurality of load sensors include voltage sensor 103a and current sensor 103b. The voltage sensor 103a determines the voltage of the power signal S_{Power} and provides a signal S_{Voltage} in response. The signal S_{Voltage} increases and decreases in response to the voltage of the power signal S_{Power} increasing and decreasing, respectively. The current sensor 103b determines the current of the power signal S_{Power} and provides a signal S_{Current} in response. The signal S_{Current} increases and decreases in response to the current of the power signal S_{Power} increasing and decreasing, respectively.

The plurality of environmental sensors can be of many different types. In this embodiment, a water meter sensor 112a is operatively coupled to the modular card 115, wherein the water meter sensor 112a provides an environment sense signal S_{EnvSense} thereto. The environment sense signal S_{EnvSense} corresponds to an indication of an amount of water that flows through the water meter sensor 112a. the water meters sensor 112a can be used with many different types of electrical loads, such as a water pump.

In this embodiment, a motion sensor 112b is operatively coupled to the modular card 115, wherein the motion sensor 112b provides an environment sense signal S_{EnvSense} thereto. The environment sense signal S_{EnvSense} corresponds to an indication that the motion sensor 112b has detected motion. The motion sensor 112b can be used with many different types of electrical loads, such as a security system and lighting system.

In this embodiment, a humidity sensor 112c is operatively coupled to the modular card 115. wherein the humidity sensor 112c provides an environment sense signal S_{EnvSense} thereto. The environment sense signal S_{EnvSense3} corresponds to an indication of an amount of humidity determined by the humidity sensor 112c.

In this embodiment, a gas meter sensor 112d is operatively coupled to the modular card 115, wherein the gas meter sensor 112d provides an environment sense signal S_{EnvSense4} thereto. The environment sense signal S_{EnvSense} corresponds to an indication of an amount of gas determined by the gas meter sensor 112d. The gas can be of many different types, such as carbon monoxide.

In this embodiment, a smoke detector sensor 112e is operatively coupled to the modular card 115, wherein the smoke detector sensor 112c provides an environment sense signal S_{EnvSense5} thereto. The environment sense signal S_{EnvSense5} corresponds to an indication that the smoke detector sensor 112e has detected smoke.

In this embodiment, a temperature sensor 112f is operatively coupled to the modular card 115, wherein the temperature sensor 112f provides an environment sense signal S_{EnvSense4} thereto. The environment sense signal S_{EnvSense6} corresponds to an indication of a temperature determined by the temperature sensor 112f.

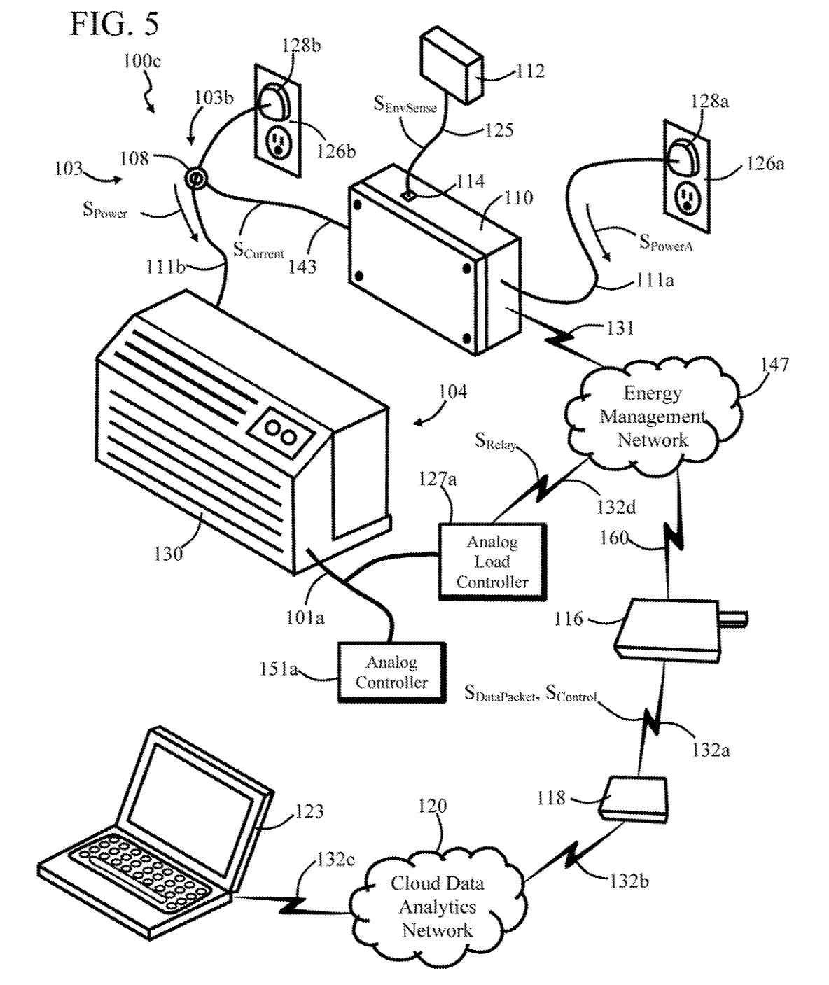

FIG. 5 is a perspective view of an energy management system 100c. In this embodiment, the energy management system 100c includes a metering system 110. The metering system 110 can be of many different types, several of which will be discussed in more detail below. The metering system 110 is operatively coupled to an electrical outlet 126a through a power cord 111a and a plug 128a.

The power cord 111a can be of many different types. In general, the power cord 111a includes one or more wires, wherein each wire flows a portion of the power signal S_{PowerA}. For example, the power signal S_{PowerA} can include a single signal, such as in a single phase signal, so that the power cord 111a includes a single wire. Examples of a single phase signals include a 120 VAC single phase power signal. which is commonly used in The United States. The power signal S_{PowerA} can include two signals, such as in a two-phase signal, so that the power cord 111a includes two wires. Examples of two phase signals include 220 VAC and 240 VAC two phase power signals. The power signal S_{PowerA} can include three signals, such as in a three-phase signal, so that the power cord 111a includes three wires. Examples of three phase signals include 208 VAC and 220 VAC three phase power signals, which are commonly used in the United States.

In this embodiment, the energy management system 100c includes the environmental sensor 112, which is discussed in more detail above. It should be noted that the environmental sensor 112 can include one or more of the sensors of FIG, 4. if desired. The environmental sensor 112 is in communication with the metering system 110. The environmental sensor 112 can be in communication with the metering system 110 in many different ways, such as through a wired and wireless communication link. In this embodiment, the metering system 110 includes a sensor port 114 which is connected to the environmental system 112 through a cable 125. The environment sense signal S_{EnvSense} flows between the metering system 110 and environmental sensor 112 through the cable 125 and sensor port 114. In this way, the environmental sensor 112 is in communication with the metering system 110 through a wired communication link.

In this embodiment, the energy management system 100c includes the electrical load 104, which is embodied as an AC unit 130. If should be noted that the electrical load of FIG. 5 can be any of the electrical loads mentioned above with FIG. 3. The AC unit 130 is operatively coupled to an electrical outlet 126b through a power cord 111b and a plug 128b. The power cord 111b can be of many different types. In general, the power cord 111b includes one or more wires, wherein each wire flows a portion of the power signal S_{Power} (FIG. 3), For example, the power signal S_{Power} can include a single signal, such as in a single phase signal, so that the power cord 111b includes a single wire. Examples of a single phase signal include a 120 VAC single phase power signal, which is commonly used in the United States. The power signal S_{Power} can include two signals, such as in a two-phase signal, so that the power cord 111b includes two wires. Examples of two phase signals include 220 VAC and 240 VAC two phase power signals. The power signal S_{Power} can include three signals, such as in a three-phase signal, so that the power cord 111b includes three wires. Examples of three phase signals include 208 VAC and 220 VAC three phase power signals, which are commonly used in the United States.

In this embodiment, the energy management system 100c includes the load sensor 103 (FIG. 3) operatively coupled to the power cord 111b, wherein the load sensor 103 is embodied as the current sensor 103b (FIG. 4). The current sensor 103b provides the current signal S_{Current} to the metering system 110 through a cable 143 in response to a current flow through the power cord 111b. It should be noted that the current sensor S_{Current} corresponds to the load sense signal S_{LoadSense} of FIG. 3. The current sensor 103b can be of many different types. In this embodiment, the current sensor 103b is embodied as a current transformer 108. It should be noted that the current sensor 103b generally includes one or more current transformers. For example, the current sensor 103b can include a current transformer for each wire of the power cord 111b. One current transformer is shown in FIG. 5 for illustrative purposes. The cable 143 can be of many different types. In general, the cable 143 includes one or more wires, wherein each wire flows a portion of the current signal S_{Current}. In general, the cable 143 includes the same number of wires as the power cord 111b so that the cable 143 flows a current signal corresponding to a power signal flowing on each wire of the power cord 111b. One type of cable is commonly referred to as ROMEX.

In this embodiment, the energy management system 100b includes the energy management data packet network 147. which is in communication with the metering system 110 through a communication link 131. In particular, the energy-management data packet network 147 is in communication with the modular card 115 (FIG. 1), which is included with the metering system 110. The energy management data packet network 147 can be in communication with the modular card 115 in many different ways. In some embodiments, the energy management data packet network 147 is in communication with the modular card 115 through a wired communication link, such as an Ethernet cable. In other embodiments, the energy management data packet network 147 is in communication with the modular card 115 through a wireless communication link, such as a wireless router. Hence, in the embodiments disclosed herein, the communication link 131 can be a wired communication link and a wireless communication link. It should be noted that the control signal S_{Control} and data packet S_{DataPacket} flow through the communication link 131.

In this embodiment, the energy management system 100c includes an analog load controller 127a, which is in communication with the energy management data packet network 147 through a communication link 132d. The energy management system 100c includes an analog controller 151a, which is connected to the AC unit 130 through an analog control loop 101a. The operation of the AC unit 130 can be controlled using the analog controller 151a. The analog load controller 127a is coupled to the analog control loop 101a. The operation of the AC unit 130 can be controlled with the analog load controller 127a. In operations, the analog load controller 127a controls the operation of the AC unit 130 in response to receiving the relay signal S_{relay} which is provided by the energy management data packet network 147. In some embodiments, the information of the relay signal S_{relay} is included with the control signal S_{Control}.

In this embodiment, the energy management system 100c includes the energy gateway processor server 116 in communication with the energy management data packet network 147. The energy gateway processor server 116 can be in communication with the energy management data packet network 147 in many different ways, such as through a wired communication link. In this embodiment, the energy gateway processor server 116 is in communication with the metering system 110 through a wireless communication link 160. In the energy management system 100c, the energy gateway processor server 116 is embodied as a router, which is capable of establishing wired and wireless communication links.

In this embodiment, the energy management system 100c includes a communication network 118 in communication with the energy gateway processor server 116. The communication network 118 can be in communication with the energy gateway processor server 116 in many different ways, such as through a wired and wireless communication link. In this embodiment, a wireless communication link 132a is established between the energy gateway processor server 116 and communication network 118. The communication network 118 can be of many different types, such as a wide area network (WAN) and a large area network (LAN).

In this embodiment, the energy management system 100c includes the cloud data analytics network 120 in communication with the communication network 118. The cloud data analytics network 120 can be in communication with the communication network 118 in many different ways, such as through a wired and wireless communication link. In this embodiment, a wireless communication link 132b is established between the communication network 118 and cloud data analytics network 120. The cloud data analytics network 120 is typically a remote network that can lie accessed remotely by a user having predetermined access credentials.

The user can access the cloud data analytics network 120 in many different ways. In this embodiment, the user accesses the cloud data analytics network 120 using a computer 123, which is embodied as a laptop computer. The computer 123 can access the cloud data analytics network 120 in many different ways, such as through a wired and wireless communication link. In this embodiment, a wireless communication link 132c is established between the cloud data analytics network 120 and computer 123. It should be noted that the user can access the cloud data analytics network 120 in many other ways, such as by using a smart phone and tablet.

In operation, the metering system 110 receives the current signal S_{Current} and environmental sense signal S_{EnvSense} from the current transformer 108 and environmental sensor 112. respectively. The modular card 115 provides the data packet S_{DataPacket} in response to receiving the load sense signal S_{SenseLoad} and environmental sense signal S_{EnvSense} as discussed above with FIGS. 1 and 3. It should be noted that the data packet S_{DataPacket} can correspond to the data packets of FIGS. 2a-2f.

In this embodiment, the data packet S_{DataPacket} is provided to the energy gateway processor server 116 through the wireless communication link 132. The data packet S_{DataPacket} is provided to the communication network 118 through the wireless communication link 132a. T he data packet S_{DataPacket} is provided to the cloud data analytics network 120 through the wireless communication link 132b. The data packet S_{DataPacket} is provided to the computer 123 through the wireless communication link 132c. The user can view the information of the data packet S_{DataPacket} using the computer 123. in particular, the user can view the information corresponding to the current signal S_{Current} and environmental sense signal S_{EnvSense}. In this way, the energy management system 100c monitors and/or adjusts the operation of the electrical load 104 using two-way communication.

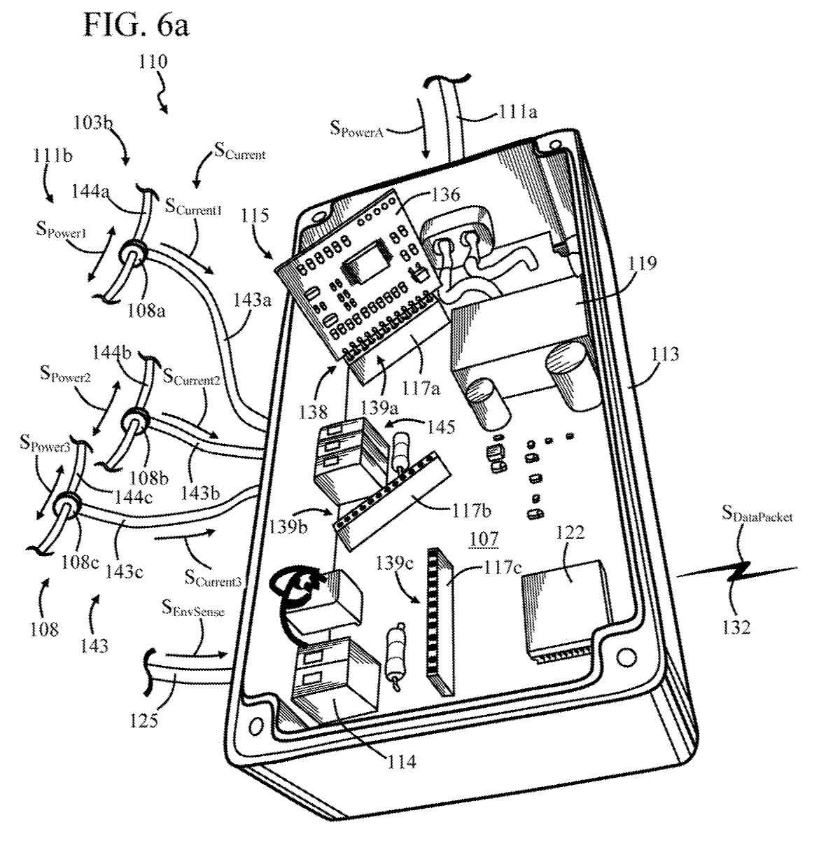

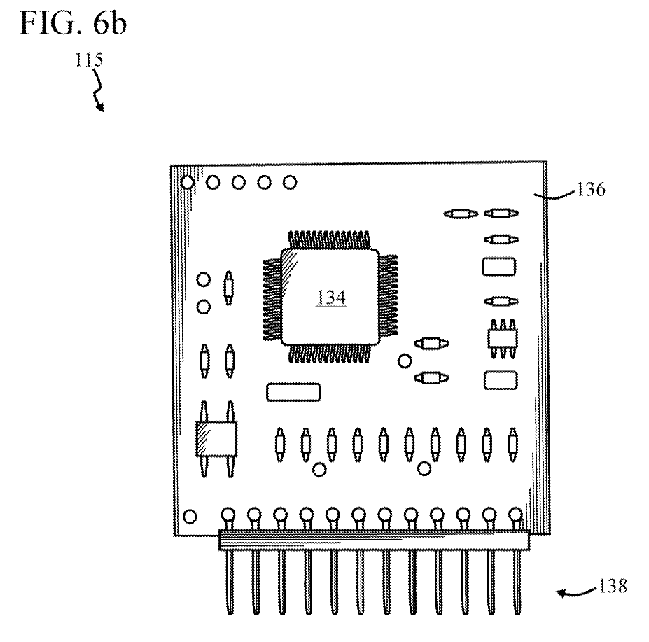

FIG 6a is a perspective view of one embodiment of the metering system 110. In this embodiment the metering system 110 includes an enclosure 113. which carries a circuit board 107. As will be discussed in more detail below, the circuit board 107 can carry many different electrical devices, and provide communication therebetween. The circuit board 107 can be of many different types, such as a printed circuit board (PCB). It should be noted that circuit board 107 typically includes one or more conductive lines thereon. However, the conductive lines are not shown in FIG. 6a for simplicity. The conductive lines extend between the electrical devices carried by the circuit board 107, and allow electrical signals to flow therebetween. The conductive lines connect the different electrical devices, and allow the electrical devices to communicate with each other. In this way, the electrical devices are coupled together.

In this embodiment, rite metering system 110 includes a power supply 119 which is coupled to the circuit board 107, wherein the power supply 119 is operatively coupled to the power cord 111a (FIG. 5). In this way, the power supply 119 provides power to the components carried by the circuit board 107 in response to receiving the power signal S_{Power} (FIG. 5).

In this embodiment, the metering system 110 includes a plurality of sockets 117a, 117b. and 117c which are carried by the circuit board 107. The metering system 110 generally includes one or more sockets 117a, 117b, and 117c. However, three sockets are shown in FIG. 6a for illustrative purposes. The sockets 117a, 117b. and 117c include interface pins openings 139a, 139b, and 139c, respectively.

In this embodiment, the metering system 110 includes a modular card 115. The metering system 110 generally includes one or more modular cards. However, one modular card 115 is shown in FIG. 6a for illustrative purposes, wherein the modular card 115 is coupled to the socket 117a. The modular card 115 can be coupled to the socket 117a in many different ways. In this embodiment, the modular card 115 includes a circuit board 136 in communication with interlace pins 138, wherein the interface pins are repeatably moveable between connected and disconnected conditions with the interface pin openings 139a. The modular card 115 is discussed in above, and will be discussed in more detail below with FIG. 6b. it should be noted that the modular card 115 can include memory for storing transitory and non-transitory signals. The transitory and non-transitory signals can correspond to many different types of signals, such as those discussed with FIGS. 2a-2f. In this way, the transitory and non-transitory signals can include the information and data discussed with FIGS. 2a-2f, such as load data, current data, date data, time data, and sensor data, among other types of data. The transitory and non-transitory signals can include packets of information to reduce the bandwidth thereof.

In this embodiment, the metering system 110 includes a wireless transceiver module 122, which is coupled to the circuit board 107. The wireless transceiver module 122 establishes the wireless communication link 132 so the data packet S_{DataPacket} can flow therebetween. The wireless transceiver module 122 can be of many different types, such as a ZIGBEE and Wi-Fi module.

In this embodiment, the metering system 110 includes the sensor port 114 (FIG. 5) connected to the circuit board 107. As discussed above, the environment sense signal S_{EnvSense} flows between the metering system 110 and environmental sensor 112 through the cable 125 and sensor port 114. The sensor port 114 allows the environment sense signal S_{EnvSense} to flow through the circuit board 107. It should be noted that the environmental sensor 112 is not shown in FIG. 6a. but it is shown in FIG. 5. As mentioned above, the environmental sensor 112 can include one or more of the sensors of FIG. 4. if desired.

In this embodiment, the metering system 110 includes a connector 145. which is connected to the circuit board 107. The metering system 110 includes the cable 143 (FIG. 5). which is connected to the connector 145. In this embodiment, the cable 143 includes a plurality of wires 143a, 143b, and 143c, which are each connected to different ports of the connector 145.

In this embodiment, the current sensor 103b is coupled to the cable 143, wherein the current sensor 103b is embodied as the current transformer 108. The current transformer 108 includes the current transformers 108a, 108b. and 108c. which are connected to the wires 143a, 143b. and 143c. respectively, of the cable 143. The power cord 111b (FIG. 5) includes the wires 144a, 144b, and 144c, wherein the current transformers 108a, 108b, and 108c are operatively coupled to the wires 144a, 144b, and 144c, respectively. Power signals S_{Power1}, S_{Power2} and S_{Power3} flow through the wires 144a, 144b, and 144c, respectively, wherein the power signals are included with the power signal S_{Power2} of FIG. 5.

The current transformer 108a determines the current of the power signal S_{Power1} and provides a current signal S_{Current} in response. The current signal S_{Current} increases and decreases in response to the current of the power signal S_{Power1} increasing and decreasing, respectively. The current signal S_{Current} flows to the corresponding port of the connector 145. The current transformer 108b determines the current of the power signal S_{Power2} and provides a current signal S_{Current2} in response. The current signal S_{Current2} increases and decreases in response to the current of the power signal S_{Power2} increasing and decreasing, respectively. The current signal S_{Current} flows to the corresponding port of the connector 145. The current transformer 108c determines the current of the power signal S_{Power3} and provides a current signal S_{Current3} in response. The current signal S_{Current3} increases and decreases in response to the current of the power signal S_{Power3} increasing and decreasing, respectively. The current signal S_{Current} flows to the corresponding port of the connector 145. It should be noted that the current signals S_{Current1}, S_{Current2} and S_{Current3} are included with the current signal S_{Current} of FIG. 5.

FIG. 6b is a side view of one embodiment of the modular card 115. In this embodiment, the modular card 115 includes the circuit board 136. The circuit board 136 can be of many different types, such as a printed circuit board (PCB), The circuit board 136 can carry many different components, and provide communication therebetween. The modular card 115 includes a microprocessor 134, which is carried by the circuit board 136. The modular card 115 includes a plurality of interface pins 138, in which one or more interface pins 138 are in communication with the microprocessor 134. In this way. one or more signals flows between the microprocessor 134 and interlace pins 138. It should be noted that the interface pins 138 are repeatably moveable between connected and unconnected conditions with the interface pins openings 139a of the socket 117a, as shown in FIG. 6a. This allows the signals of the microprocessor 134 to flow to the circuit board 107. It should also be noted that the modular card 115 can be connected to the sockets 117b and 117c. Further, additional modular cards can be connected to the sockets 117b and 117c, if desired. In general, a modular card 115 is connected to one or more of the sockets 117a. 117b, and 117c.

In operation, the metering system NO receives the current signals S_{Current1}, S_{Current2}, and S_{Current3} from the wires 143a, 143b, and 143c. respectively. The current signals S_{Current1}, S_{Current2}, and S_{Current3} are flowed to the modular card 115 through the socket 117a, connector 145, and interface pins 138. It should be noted that the current signals S_{Current1}, S_{Current2}, and S_{Current3} are flowed between the connector 145 and socket 117a through conductive lines of the circuit board 107. However, these conductive lines are not shown in FIG. 6a for simplicity.

In operation, the environmental sense signal S_{EnvSense} is flowed to the modular card 115 through the sensor port 114, socket 117a, and interlace pins 138. It should be noted that the environmental sense signal S_{EnvSense} is flowed between the sensor port 114 and socket 117a through conductive lines of the circuit board 107. However, these conductive lines are not shown in FIG. 6a for simplicity.

In operation, the modular card 115 provides the data packet S_{DataPacket} in response to receiving the current signals S_{Current1}, S_{Current2}, and S_{Current3} and environmental sense signal S_{EnvSense}, as discussed above with FIGS. 1 and 3. It should be noted that the data packet S_{DataPacket} can correspond to the data packets S_{DataPacket} of FIGS. 2a-2f.

In operation, the data packet S_{DataPacket} is flowed to the wireless transceiver module 122 through a conductive line that extends between the wireless transceiver module 122 and socket 117a. However, the conductive line between the wireless transceiver module 122 and socket 117a is not shown in FIG. 6a for simplicity.

In operation, the wireless transceiver module 122 flows the data packet S_{DataPacket}, as discussed in more detail above. In particular, the data packet S_{DataPacket} is flowed to the energy gateway processor server 116 through the wireless communication link 132. The data packet S_{DataPacket} is provided to the communication network 118 through the w ireless communication link 132a. The data packet S_{DataPacket} is provided to the cloud data analytics network 120 through the wireless communication link 132b. The data packet S_{DataPacket} is provided to the computer 123 through the wireless communication link 132c. The user can view the information of the data packet S_{DataPacket} using the computer 123. In particular, the user can view the information corresponding to the current signal S_{Current} and environmental sense signal S_{EnvSense}. In this way, the energy management system 100c monitors and/or adjusts the operation of the electrical load 104 using two-way communication.

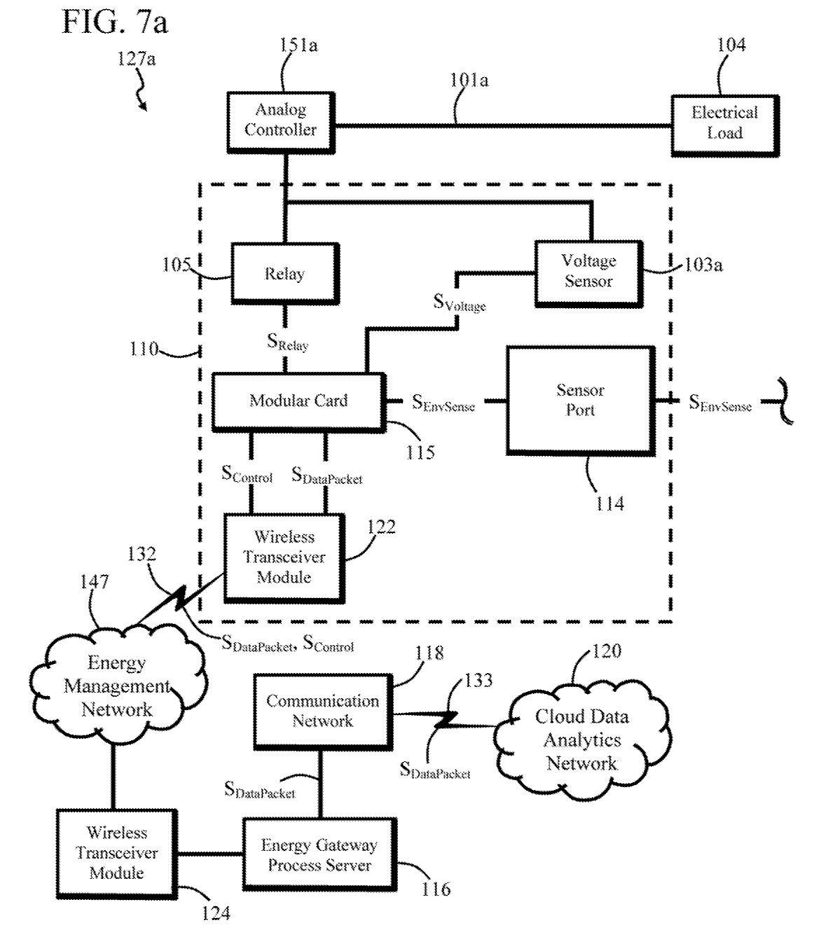

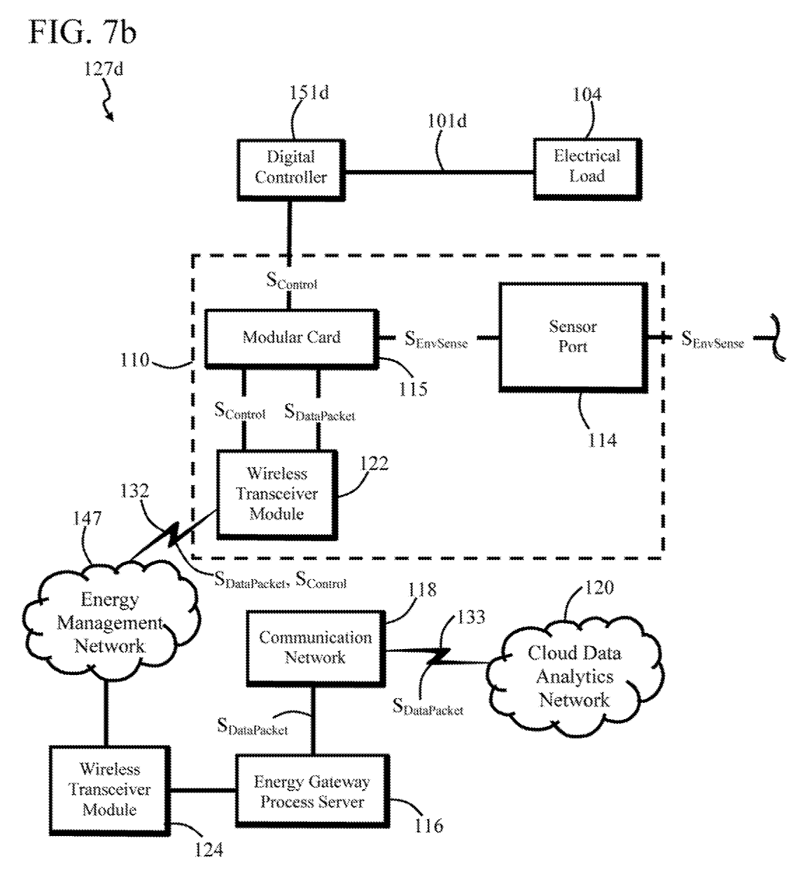

FIG. 7a is a block diagram of an analog load controller 127a. which includes a metering system 119, modular card 115, and an analog controller 151a. In this embodiment, the metering system 110 includes the modular card 115. The metering system 110 includes the sensor port 114 in communication with the modular card 115, wherein the environmental sense signal S_{EnvSense} flows therebetween. As discussed in more detail above, the environmental sense signal S_{EnvSense} is provided by a sensor, such as the sensors discussed above. The metering system 110 includes the voltage sensor 103a in communication with the modular card so the voltage signal S_{Voltage} flows therebetween.

In this embodiment, the relay 105 and voltage sensor 103a are connected to the analog controller 151a, and the analog controller 151a is connected to The electrical load 104 through the analog control loop 101a. The relay 105 controls the operation of the analog controller 151a in response to receiving the relay signal S_{Relay}. The voltage sensor 103a determines the voltage between the analog controller 151a and relay 105. and provides the voltage signal S_{Voltage} in response.

In this embodiment, the metering system 110 includes the wireless transceiver module 122 in communication with the modular card 115 so the control signal S_{Control} and data packet S_{DataPacket} flow therebetween. The wireless transceiver module 122 establishes the wireless communication link 132, as discussed above with FIGS. 3,5, and 6a. wherein the control signal S_{Control} and data packet S_{DataPacket} flow therethrough. It should be noted that, in this embodiment, the sensor port 114. modular card 115, voltage sensor 103a and wireless transceiver module 122 can be carried by the circuit board 107, as shown in FIG. 6a.

In this embodiment, the analog load controller 127a includes the energy management data packet network 147, which is in communication with the metering system 110 through the communication link 132. In particular, the energy management data packet network 147 is in communication with the wireless transceiver module 122, which is included with the metering system 110. The energy management data packet network 147 can be in communication with the wireless transceiver module 122 in many different ways. In some embodiments, the energy management data packet network 147 is in communication with the wireless transceiver module 122 through a wired communication link, such as an Ethernet cable. In other embodiments, the energy management data packet network 147 is in communication with the wireless transceiver module 122 through a wireless communication link, such as a wireless router. Hence, in the embodiments disclosed herein, the communication link 132 can be a wired communication link and a wireless communication link. It should be noted that the control signal S_{Control} and data packet S_{DataPacket} flow through the communication link 132. The control signal S_{Control} can include information regarding the relay signal S_{Relay}. The data packet S_{DataPacket} can include information regarding the voltage signal S_{Voltage} and the environmental sense signal S_{EnvSense}.

In this embodiment, the analog load controller 127a includes the wireless transceiver module 124 in communication with the energy management data packet network 147. The analog load controller 127a includes the energy gateway processor server 116 in communication with the wireless transceiver module 124. and the communication network 118 in communication with the energy gateway processor server 116. The analog load controller 127a includes the cloud data analytics network 120 in communication with the communication network 118 through the communication link 133.

In operation, the data packet S_{DataPacket} is flowed to the wireless transceiver module 122 through a conductive line that extends between the wireless transceiver module 122 and socket 117a. However, the conductive line between the wireless transceiver module 122 and socket 117a is not shown in FIG. 6a for simplicity.

In operation, the wireless transceiver module 122 flows the data packet S_{DataPacket}, as discussed in more detail above. In particular, the data packet S_{DataPacket} is flowed to the energy gateway processor server 116 through the wireless communication link 132, energy management data packet network 147. and wireless transceiver module 124. The data packet S_{DataPacket} is provided to the communication network 118 through the wireless communication link. 132a. The data packet S_{DataPacket} is provided to the cloud data analytics network 120 through the wireless communication link 132b. The data packet S_{DataPacket} is provided to the computer 123 through the wireless communication link 132c. The user can view the information of the data packet S_{DataPacket} using the computer 123. In particular, the user can view the information corresponding to the current signal S_{Current} and environmental sense signal S_{EnvSense}. In this way. the energy management system 100c monitors and/or adjusts the operation of the electrical load 104 using two-way communication.

FIG. 7b is a block diagram of a digital load controller 127d. which includes the metering system 110, modular card 115, and a digital controller 151d. In this embodiment, the metering system 110 includes the modular card 115. The metering system 110 includes the sensor port 114 in communication with the modular card 115, wherein the environmental sense signal S_{EnvSense} flows therebetween. As discussed in more detail above, the environmental sense signal S_{EnvSense} is provided by a sensor, such as the sensors discussed above. The metering system 110 includes the voltage sensor 103a in communication with the modular card so the voltage signal S_{Voltage} flows therebetween.

In this embodiment, the digital controller 151d is connected to the modular card 115, so the control signal S_{Control} flows therebetween. The digital controller 151d is connected to the electrical load 104 through a digital control loop 101d. The digital controller 151d controls the operation of the electrical load 104 in response to the control signal S_{Control} should be noted that the control signal S_{Control} can flow between the modular card 115 and digital controller 151d on a serial link.

In this embodiment, the metering system 110 includes the wireless transceiver module 122 in communication with the modular card 115 so the control signal S_{Control} and data packet S_{DataPacket} flow therebetween. The wireless transceiver module 122 establishes the wireless communication link 132, as discussed above with FIGS. 3, 5, and 6a. wherein the control signal S_{Control} and data packet S_{DataPacket} flow therethrough. It should be noted that, in this embodiment, the sensor port 114, modular card 115, voltage sensor 103a and wireless transceiver module 122 can be carried by the circuit board 107, as shown in FIG. 6a.

In this embodiment, the digital load controller 127d includes the energy management data packet network 147, which is in communication with the metering system 110 through the communication link 132. In particular, the energy management data packet network 147 is in communication with the wireless transceiver module 122, which is included with the metering system 110. The energy management data packet network 147 can be in communication with the wireless transceiver module 122 in many different ways. In some embodiments, the energy management data packet network 147 is in communication with the wireless transceiver module 122 through a wired communication link, such as an Ethernet cable. In other embodiments, the energy management data packet network 147 is in communication with the wireless transceiver module 122 through a wireless communication link, such as a wireless router. Hence, in the embodiments disclosed herein, the communication link 132 can be a wired communication link and a wireless communication link. It should be noted that the control signal S_{Control} and data packet S_{DataPacket} flow through the communication link 132. The control signal S_{Control} can include information regarding the relay signal S_{Relay}. The data packet S_{DataPacket} can include information regarding the voltage signal S_{Voltage} and the environmental sense signal S_{EnvSense}.

In this embodiment, the digital load controller 127d includes the wireless transceiver module 124 in communication with the energy management data packet network 147. The digital load controller 127d includes the energy gateway processor server 116 in communication with the wireless transceiver module 124, and the communication network 118 in communication with the energy gateway processor server 116. The digital load controller 127d includes the cloud data analytics network 120 in communication with the communication network 118 through the communication link 133.

In operation, the data packet S_{DataPacket} is flowed to the wireless transceiver module 122 through a conductive line that extends between the wireless transceiver module 122 and socket 117a. However, the conductive line between the wireless transceiver module 122 and socket 117a is not shown in FIG. 6a for simplicity.

In operation, the wireless transceiver module 122 flows the data packet S_{DataPacket}, as discussed in more detail above. In particular, the data packet S_{DataPacket} is flowed to the energy gateway processor server 116 through the wireless communication link 132. energy management data packet network 147, and wireless transceiver module 124. The data packet S_{DataPacket} is provided to the communication network 118 through the wireless communication link 132a. The data packet S_{DataPacket} is provided to the cloud data analytics network 120 through the wireless communication link 132b. The data packet S_{DataPacket} is provided to the computer 123 through the wireless communication link 132c. The user can view the information of the data packet S_{DataPacket} using the computer 123. In particular, the user can view the information corresponding to the current signal S_{Current} and environmental sense signal S_{EnvSense}. In this way, the energy management system 100c monitors and/or adjusts the operation of the electrical load 104 using two-way communication.

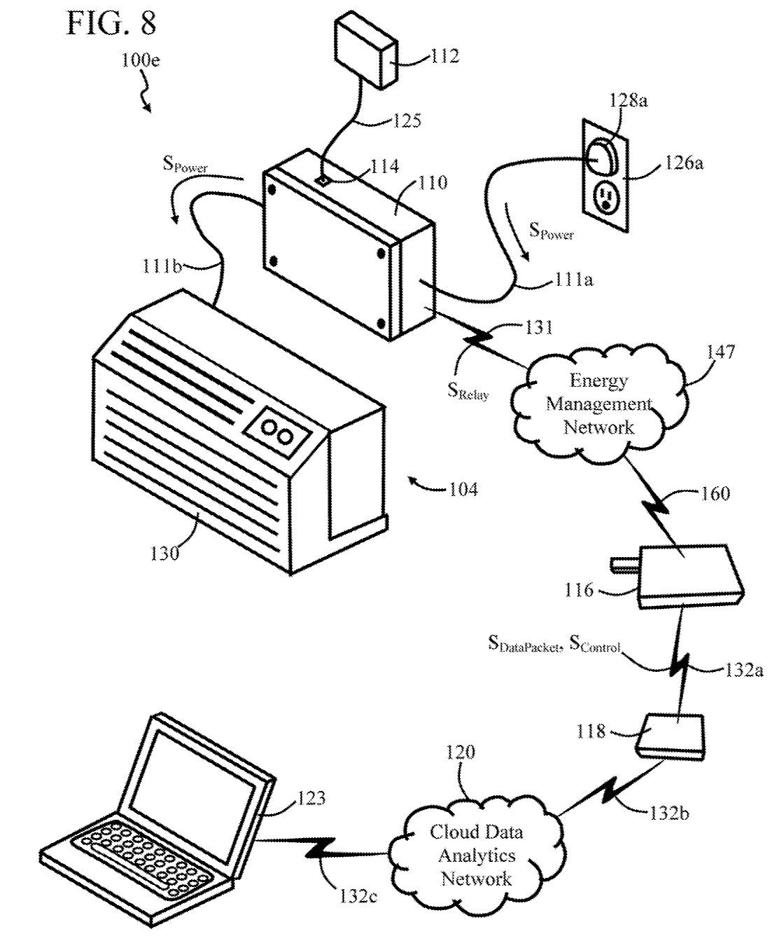

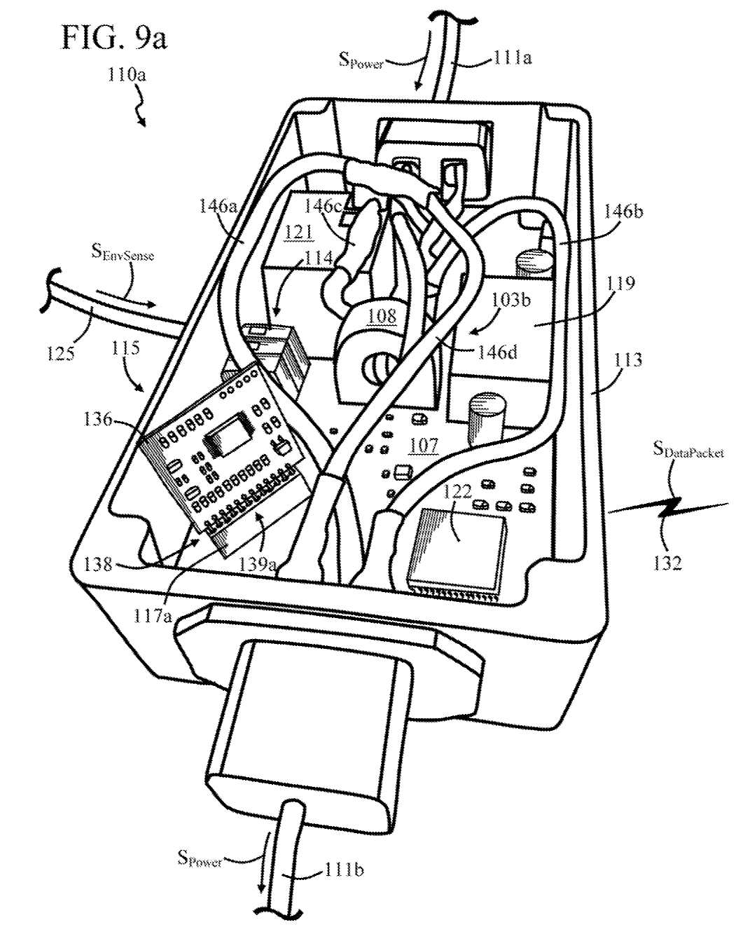

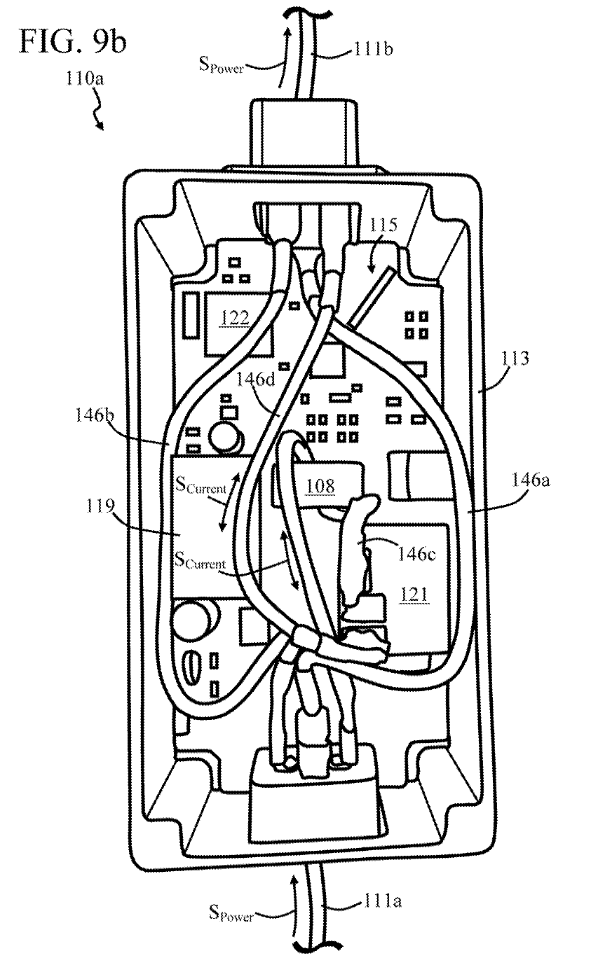

FIG. 8 is a perspective view of an energy management system 100e. In this embodiment, the energy management: system 100e includes the metering system 110. As discussed above, the metering system 110 can be of many different types. The metering system 110 is operatively coupled to the electrical outlet 126a through the power cord 111a and plug 128a.

As discussed above, the power cord 111a can be of many different types. In general, the power cord 111a includes one or more wires, wherein each wire flows a portion of the power signal S_{Power}. For example, the power signal S_{Power} can include a single signal, such as in a single phase signal, so that the power cord 111a includes a single wire. Examples of a three phase signal include a 120 VAC single phase power signal, which is commonly used in the United States. The power signal S_{Power} can include two signals, such as in a two-phase signal, so that the power cord 111a includes two wires. The power signal S_{Power} can include three signals, such as in a three-phase signal, so that the power cord 111a includes three wires. Examples of three phase signals include 220 VAC and 240 VAC three phase power signals, which are commonly used in the United States.

In this embodiment, the energy management system 100c includes the environmental sensor 112, which is discussed in more detail above. It should be noted that the environmental sensor 112 can include one or more of the sensors of FIG. 4. if desired. The environmental sensor 112 is operatively coupled to the metering system 110. The environmental sensor 112 can be operatively coupled to the metering system 110 in many different ways, such as through a wired and wireless communication link. In this embodiment, the metering system 110 includes the sensor port 114 that is connected to the environmental system 112 through the cable 125. The environment sense signal S_{EnvSense} flows between the metering system 110 and environmental sensor 112 through the cable 125 and sensor port 114. In this way, the environmental sensor 112 is operatively in communication with the metering system 110 through a wired communication link.

In this embodiment, the energy management system 100e includes the electrical load, which is embodied as the AC unit 130. It should be noted that the electrical load of FIG. 8 can be any of the electrical loads mentioned above with FIG. 3. The AC unit 130 is operatively coupled to the metering system 110 through the power cord 111b. The power cord 111b can be of many different types. In general, the power cord 111b includes one or more wires, wherein each wire flows a portion of the power signal S_{Power}. As mentioned above, the power signal S_{Power} is provided by the electrical outlet 126a. As will be discussed in more detail below, the metering system 110 determines the voltage and current of the power signal S_{Power}.

In this embodiment, the energy management system 100e includes the energy management data packet network 147, which is in communication with the metering system 110 through the communication link 131. The energy management data packet network 147 can be in communication with the metering system 110 in many different ways. In some embodiments, the energy management data packet network 147 is in communication with the metering system 110 through a wired communication link, such as an Ethernet cable. In other embodiments, the energy management data packet network 147 is in communication with the metering system 110 through a wireless communication link, such as a wireless router. Hence, in the embodiments disclosed herein, a communication link 131 can be a wired communication link and a wireless communication link. It should be noted that the control signal S_{Control}, data packet S_{DataPacket}, and relay signal S_{Relay} flow through the communication link 131.

In this embodiment, the energy management system 100e includes the energy gateway processor server 116 in communication with the energy management data packet network 147. The energy gateway processor server 116 can be in communication with the energy management data packet network 147 in many different ways, such as through a wired communication link. In this embodiment, the energy gateway processor server 116 is in communication with the energy management data packet network 147 through the wireless communication link 160. In the energy management system 100c, the energy gateway processor server 116 is embodied as a router that is capable of establishing wired and wireless communication links.

In this embodiment, the energy management system 100c includes the communication network 118 in communication with the energy gateway processor server 116. The communication network 118 can be in communication with the energy gateway processor server 116 in many different ways, such as through a wired and wireless communication link, in this embodiment, the wireless communication link 132a is established between the energy gateway processor server 116 and communication network 118. The communication network 118 can be of many different types, such as a wide area network (WAN) and a large area network (LAN).

In this embodiment, the energy management system 100e includes the cloud data analytics network 120 in communication with the communication network 118. The cloud data analytics network 120 can be in communication with the communication network 118 in many different ways, such as through a wired and wireless communication link. In this embodiment, the wireless communication link 132b is established between the communication network 118 and cloud data analytics network 120. The cloud data analytics network 120 is typically a remote network that can be accessed remotely by a user having predetermined access credentials.

In this embodiment, the user accesses the cloud data analytics network 120 through a computer 123. which is embodied as a laptop computer. The computer 123 can access the cloud data analytics network 120 in many different ways, such as through a wired and wireless communication link. In this embodiment, the wireless communication link 132c is established between the cloud data analytics network 120 and computer 123. As mentioned above, the user can access the cloud data analytics network 120 in many other ways, such as by using a smart phone and tablet.

In operation, the metering system 110 receives the environmental sense signal S_{EnvSense} from the environmental sensor 112. The metering system 110 provides the data packet S_{DataPacket} in response to receiving the environmental sense signal S_{EnvSense} discussed above with FIGS. 1 and 3. it should be noted that the data packet S_{DataPacket} can correspond to the data packets of FIGS. 2a-2f.

In this embodiment, the data packet S_{DataPacket} is provided to the energy gateway processor server 116 through the wireless communication link 132. The data packet S_{DataPacket} is provided to the communication network 118 through the wireless communication link 132a. The data packet S_{DataPacket} is provided to the cloud data analytics network 120 through the wireless communication link 132b. The data packet S_{DataPacket} is provided to the computer 123 through the wireless communication link 132c. The user can view the information of the data packet S_{DataPacket} using the computer 123. In particular, the user can view the information corresponding to the current signal S_{Current} and environmental sense signal S_{EnvSense}. In this way, the energy management system 100c monitors and/or adjusts the operation of the electrical load 104 using two-way communication.

FIGS. 9a and 9b are is a perspective and top views, respectively, of another embodiment of a metering system, denoted as metering system 110a. In this embodiment the metering system 110a includes the enclosure 113, which carries the circuit board 107. As discussed above, the circuit board 107 can carry many different components, and provide communication therebetween. As mentioned above, the circuit board 107 can be of many different types, such as a printed circuit board (PCB).

In this embodiment, the metering system 110a includes the socket 117a, which is carried by the circuit board 107. As mentioned above, the metering system 110a generally includes one or more sockets. However, one socket is shown in FIGS. 9a and 9b for illustrative purposes. The socket 117a includes interlace pins openings 139a.

In this embodiment, the metering system 110a includes the modular card 115. The metering system 110a generally includes one or more modular cards. However, one modular card 115 is shown in FIGS. 9a and 9b for illustrative purposes, wherein the modular card 115 is coupled to the socket 117a. The modular card 115 can be coupled to the socket 117a in many different ways. In this embodiment, the modular card 115 includes the circuit board 136 in communication with interface pins 138, wherein the interface pins are repeatably moveable between connected and disconnected conditions with the interface pin openings 139a. The modular card 115 is discussed in more detail above.

In this embodiment, the metering system 110a includes the wireless transceiver module 122, which is coupled to the circuit board 107. The wireless transceiver module 122 establishes the wireless communication link 132 so the data packet S_{DataPacket} can flow therebetween. The wireless transceiver module 122 can be of many different types, such as a ZIGBEE and Wi-Fi module.

As shown in FIGS. 9a and 9b, the metering system 110a includes the sensor port 114 (FIG. 8) connected to the circuit board 107. The environment sense signal S_{EnvSense} flows between the metering system 110a and environmental sensor 112 through the cable 125 and sensor port 114. The sensor port 114 allows the environment sense signal S_{EnvSense} to flow through the circuit board 107. It should be noted that the environmental sensor 112 is not shown in FIGS. 9a and 9b, but it is shown in FIG. 8. As mentioned above, the environmental sensor 112 can include one or more of the sensors of FIG. 4. if desired.

In this embodiment, the metering system 110a includes the power supply 119 which is coupled to the circuit board 107. wherein the power supply 119 is operatively connected to the power cord 111a. In this way, the power supply 119 provides power to the components carried by the circuit board 107 in response to receiving the power signal S_{Power} (FIG. 8). The metering system 110a includes the power cord 111b, which is connected to the power cord 11 la. In this embodiment, the metering system 110a includes the current sensor 103b, which is embodied as the current transformer 108. it should be noted that the power signal S_{Power} flows between the power cords 111a and 111b.

In this embodiment, the metering system 110a includes a wire 146a. which is connected to a first wire of the power cord 111a and a first wire of the power cord 111b. The first wire 146a allows a neutral signal to flow between the first wires of the power cords 111a and 111b. The metering system 110a includes a wire 146b, which is connected to a second wire of the power cord 111a and a second wire of the power cord 111b. The second wire 146b allows the current signal S_{Current} to flow between the second wires of the power cords 111a and 111b.

In this embodiment, the metering system 110a includes a wire 146c, which is connected to a third wire of the power cord 111a and a first terminal of a relay 121. The relay 121 is coupled to the circuit board 107. The metering system 110a includes a wire 146d, which is connected to a third wire of the power cord 111b and a second terminal of the relay 121. It should be noted that the wire 145c extends through the current sensor 103b. In particular, the wire 145c extends through the current transformer 108. The wire 146c allows the current signal S_{Current} to flow through the current sensor 103b. The relay is repeatably moveable between open and closed conditions. In the closed condition, the current signal S_{Current} is allowed to flow through the current sensor 103b. and between the first and second terminals of the relay 121. In the open condition, the current signal S_{Current2} restricted from flowing through the current sensor 103b. and between the first and second terminals of the relay 121.

Hence, in this embodiment, the wires 146c and 146d are in communication with each other in response to the relay 121 being in the closed condition. The wires 146c and 146d allow the current signal S_{Current2} to flow between the third wires of the power cords 111a and 111b in response to the relay being in the closed condition. Further, the wires 146c and 146d are not in communication with each other in response to the relay 121 being in the open condition. The wires 146c and 146d do not allow the current signal S_{Current} to flow between the third wires of the power cords 111a and 111b in response to the relay being in the open condition.

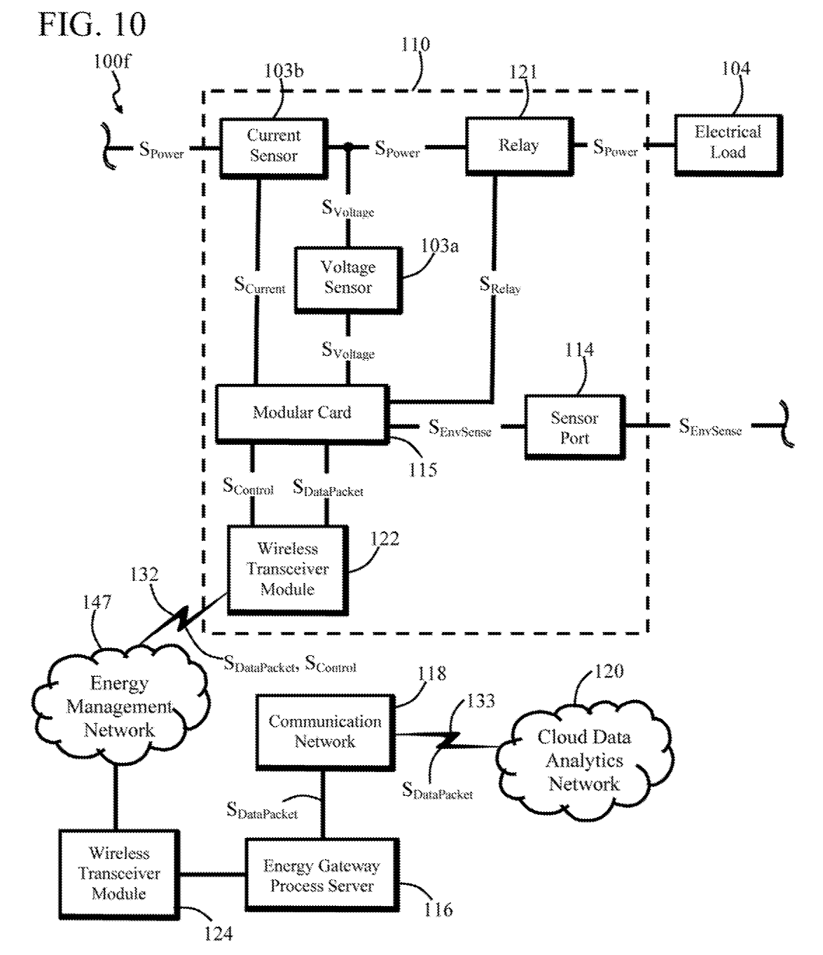

FIG. 10 is a block diagram of an energy management system 100f. In this embodiment, the energy management system 100f includes the metering system 110, wherein the metering system 110 includes die modular card 115. The metering system 110 includes the sensor port 114 in communication with the modular card 115, wherein the environmental sense signal S_{EnvSense} flows therebetween. As discussed in more detail above, the environmental sense signal S_{EnvSense} is provided by a sensor, such as the sensors discussed above. For example, the environmental sensor can include one or more of the sensors of FIG. 4. if desired.

In this embodiment, the metering system 110 includes the voltage sensor 103a in communication with the modular card 115 so the voltage signal S_{Voltage} flows therebetween. Further, the energy management system 100f includes the current sensor 103b in communication with the modular card 115 so the current signal S_{Current} flows therebetween. The energy management system 100f includes the relay 121 in communication with the modular card 115 so the relay signal S_{Relay} flows therebetween. The energy management system 100f includes the electrical load 104 in communication with the relay 121. The electrical load 104 operates in response to the power signal S_{Power}, wherein the voltage sensor 103a determines the voltage of the power signal S_{Power} and the current sensor 103b determines the current of the power signal S_{Power}. The relay 121 controls the flow of the power signal S_{Power} to the electrical load 104. In some situations, the relay 121 controls the flow of the power signal S_{Power} to the electrical load 104 in response to receiving the relay signal S_{Relay}. It should be noted that the electrical load 104 of FIG. 10 can be any of the electrical loads mentioned above with FIG. 3. The electrical load 104 of FIG. 10 can be a low voltage load, such as a light and small motor.

In this embodiment, the metering system 110 includes the wireless transceiver module 122 in communication with the modular card 115 so the control signal S_{Control} and data packet S_{DataPacket} flow therebetween. The wireless transceiver module 122 establishes the wireless communication link 132, as discussed above with FIG. 6a, wherein the control signal S_{Control} and data packet S_{DataPacket} flow therethrough. It should be noted that, in this embodiment, the sensor port 114. modular card 115, voltage sensor 103a, current sensor 103b, relay 121. and wireless transceiver module 122 are carried by the circuit board 107. as shown in FIGS. 9a and 9b.

In this embodiment, the energy management system 100f includes the energy management data packet network 147, which is in communication with the metering system 110 through the communication link 132. In particular, the energy management data packet network 147 is in communication with the wireless transceiver module 122, which is included with the metering system 110. The energy management data packet network 147 can be in communication with the wireless transceiver module 122 in many different ways. In some embodiments, the energy management data packet network 147 is in communication with the wireless transceiver module 122 through a wired communication link, such as an Ethernet cable. In other embodiments, the energy management data packet network 147 is in communication with the wireless transceiver module 122 through a wireless communication link, such as a wireless router. Hence, in the embodiments disclosed herein, the communication link 132 can be a wired communication link and a wireless communication link. It should be noted that the control signal S_{Control} and data packet S_{DataPacket} flow through the communication link 132.

In this embodiment, the energy management system 100f includes the wireless transceiver module 124 in communication with the energy management data packet network 147. The energy management system 100f includes the energy gateway processor server 116 in communication with the wireless transceiver module 124, and the communication network 118 in communication with the energy gateway processor server 116. The energy management system 100f includes the cloud data analytics network 120 in communication with the communication network 118 through the communication link 133. As mentioned above, the user can access the cloud data analytics network 120 in many different ways, such as by using a computer, smart phone, and tablet.

In operation, the data packet S_{DataPacket} is flowed to the wireless transceiver module 122 through a conductive line that extends between the wireless transceiver module 122 and modular card 115 In operation, the wireless transceiver module 122 flows the data packet S_{DataPacket} as discussed in more detail above. In particular, the data packet S_{DataPacket} is flowed to the energy gateway processor server 116 through the wireless communication link 132, energy management data packet network 147. and wireless transceiver module 124. The data packet S_{DataPacket} is provided to the communication network 118 through the energy gateway process server 116. The data packet S_{DataPacket} is provided to the cloud data analytics network 120 through the wireless communication link 133 and communication network 118. The user can view the information of the data packet S_{DataPacket} using the computer 123. if desired. In particular, the user can view the information corresponding to the current signal S_{Current} and environmental sense signal S_{EnvSense} to is way. the energy management system 100c monitors and/or adjusts the operation of the electrical load 104 using two-way communication.

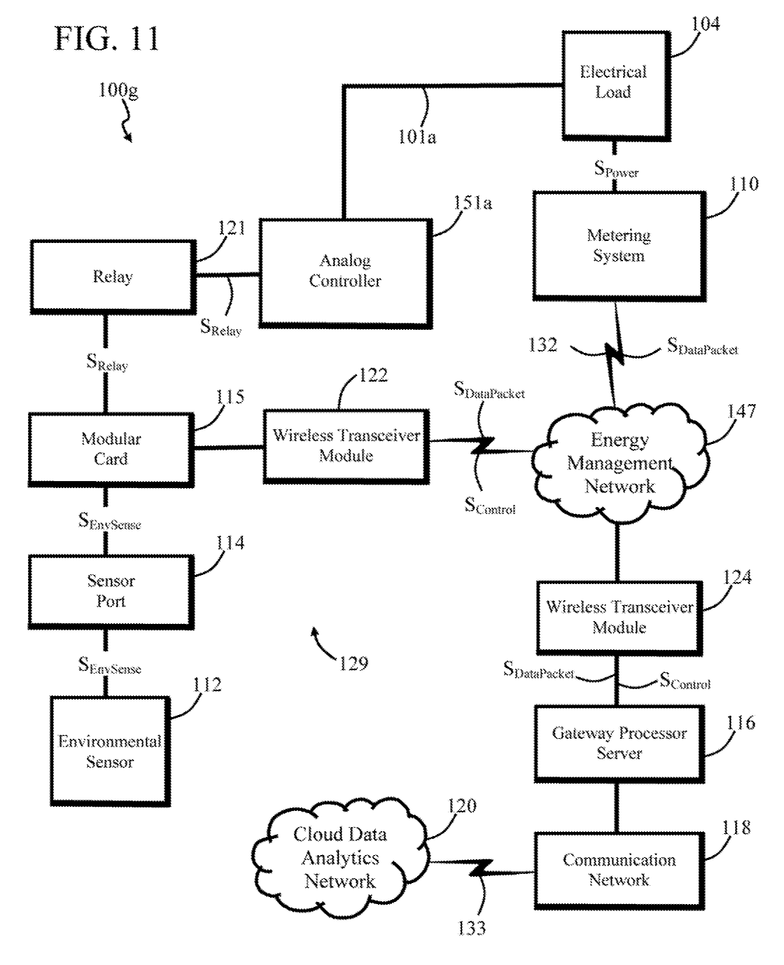

FIG. 11 is a block diagram of an energy management system 100g. In this embodiment, the energy management system 100g includes the modular card 115 in communication with the sensor port 114. The sensor port 114 is in communication with the environmental sensor 112, which can be any of the sensors discussed above. The energy management system 100g includes the relay 121 in communication with the modular card 115, and an analog controller 151a in communication with the relay 121. The analog controller 151 a is in communication with the electrical load 104, and the electrical load 104 is in communication with the metering system 110. The analog controller 151a is connected to the electrical load 104 through the analog control loop 101a. The operation of the electrical load 104 can be controlled using the analog controller 151a. In operations, the analog controller 151 a controls the operation of the electrical load 104 in response to receiving the relay signal S_{Relay}, which is provided by the relay 121. In some embodiments, the information of the relay signal S_{Relay} is included with the control signal S_{Control}.

In this embodiment, the energy management system 100g includes the wireless transceiver module 122 in communication with the modular card 115. The energy management system 100g includes the energy management data packet network 147 in communication with the metering system and wireless transceiver module 122. The energy management system 100g includes the wireless transceiver module 124 in communication with the energy management data packet network 147. and the gateway processor server 116 in communication with the wireless transceiver module 124. The energy management system 100g includes the communication network 118 in communication with the gateway service processor 116. The cloud data analytics network 120 is in communication with the communication network 118 through the communication link 133. As mentioned above, the user can access the cloud data analytics network 120 in many different ways, such as by using a computer, smart phone, and tablet.

In operation, the data packet S_{DataPacket} is flowed to the wireless transceiver module 122 through a conductive line that extends between the wireless transceiver module 122 and modular card 115. In operation, the wireless transceiver module 122 flows the data packet S_{DataPacket} as discussed in more detail above. In particular, the data packet S_{DataPacket} flowed to the energy gateway processor server 116 through energy management data packet network 147 and wireless transceiver module 124. The data packet is provided to the cloud data analytics network 120 through the gateway processor server 116. The data packet S_{DataPacket} is provided to the cloud data analytics network 120 through the communication network 118 and communication link 132. The user can view the information of the data packet S_{DataPacket} using the computer 123. In particular, the user can view the information corresponding to the current signal S_{Current} and environmental sense signal S_{EnvSense}. In this way, the energy management system 100c monitors and/or adjusts the operation of the electrical load 104 using two-way communication.

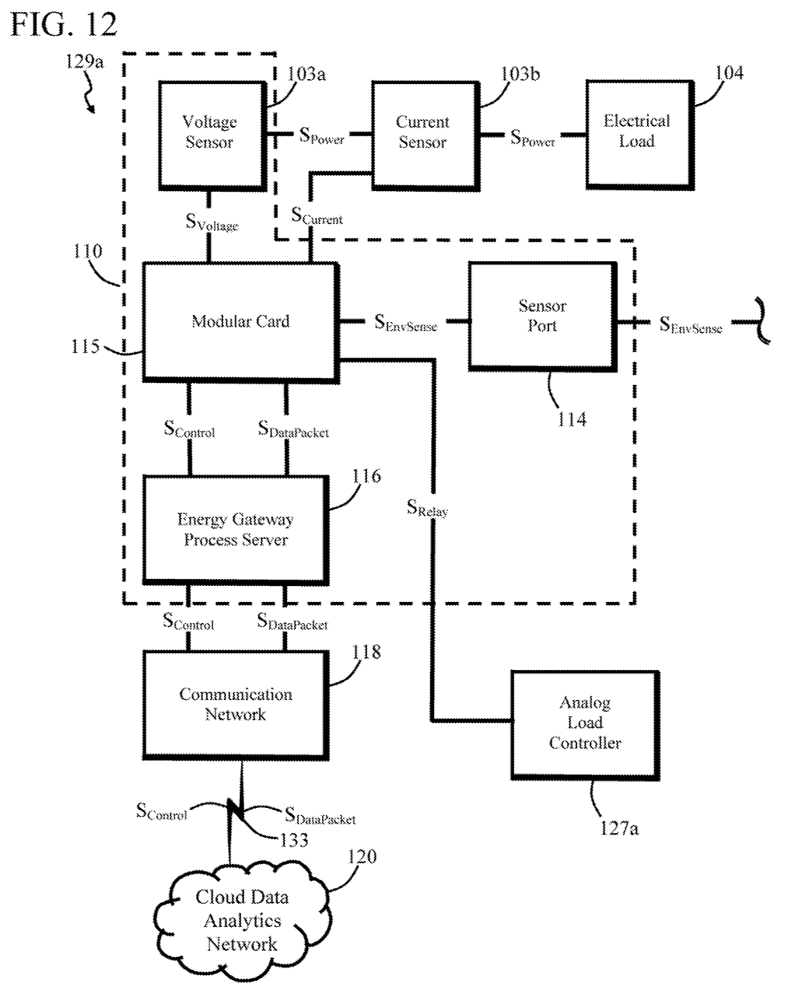

FIG. 12 is a block diagram of one embodiment of a metering panel system 129a. which includes the metering system 110. modular card 115, and analog load controller 127a. . In this embodiment, the metering system 110 includes the modular card 115. The metering system 110 includes the sensor port 114 in communication with the modular card 115, wherein the environmental sense signal S_{EnvSense} flows therebetween. As discussed in more detail above, the environmental sense signal S_{EnvSense} is provided by a sensor, such as the sensors discussed above. For example, the environmental sensor can include one or more of the sensors of FIG. 4, if desired. In this embodiment, the modular card 115 is connected to the analog load controller 127a so that the signal S_{Relay} flows therebetween. More information regarding the analog load controller 127a is provided above.

In this embodiment, the metering system 110 includes the voltage sensor 103a in communication with the modular card so the voltage signal S_{Voltage} flows therebetween. Further, the metering panel system 129a includes the current sensor 103b in communication with the modular card 115 so the current signal S_{Current} flows therebetween. The metering panel system 129a includes the electrical load 104 in communication with the current sensor 103b. The electrical load 104 operates in response to the power signal S_{Power} wherein the voltage sensor 103a determines the voltage of the power signal S_{Power}, and the current sensor 103b determines the current of the power signal S_{Power}. It should be noted that the electrical load 104 of FIG. 10 can be any of the electrical loads mentioned above with FIG. 3.

In this embodiment, the metering system 110 includes the energy gateway processor server 116 in communication with the modular card 115, and the communication network 118 in communication with the energy gateway processor server 116. It should be noted that, in this embodiment, the sensor port 114, modular card 115, voltage sensor 103a, and energy gateway processor server 116 can be carried by a circuit board, such as circuit board 107 in FIGS. 9a and 9h. The metering panel system 129a includes the cloud data analytics network 120 in communication with the communication network 118 through the communication link 133. As mentioned above, the user can access the cloud data analytics network 120 in many different ways, such as by using a computer, smart phone, and tablet. In operation, the data packet S_{DataPacket} can include voltage and current date corresponding to the operation of the electrical load 104. More information regarding the voltage and current data is provided in more detail above.

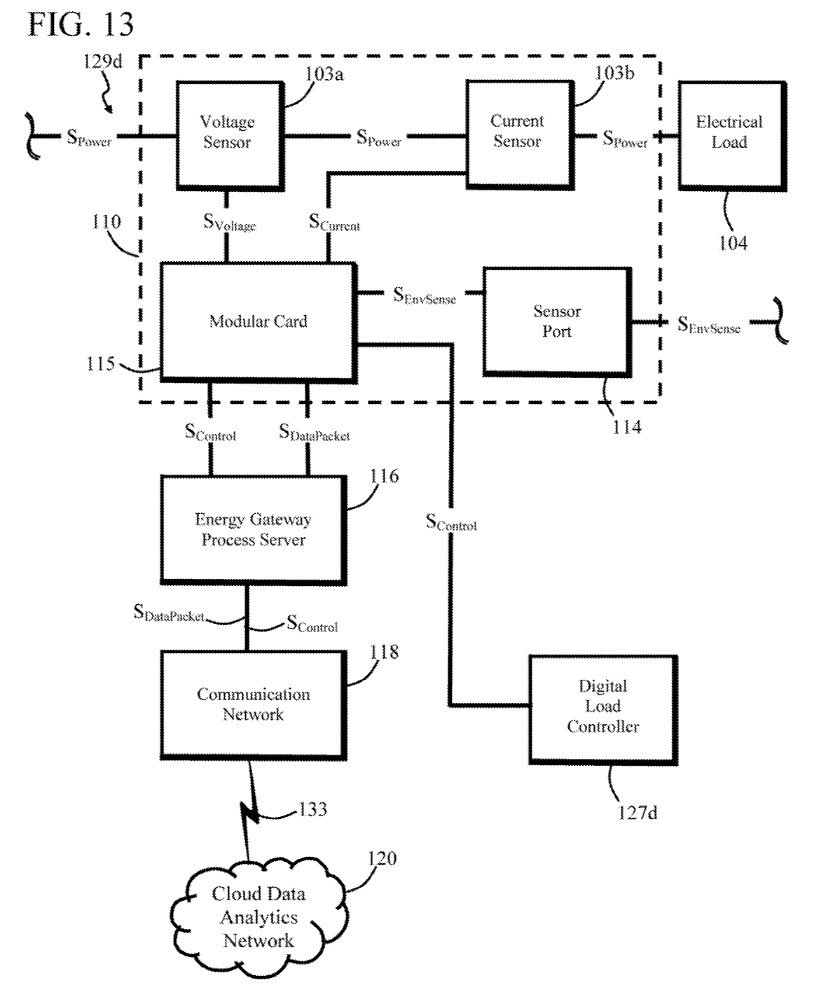

FIG. 13 is a block diagram of one embodiment of a metering panel system 129d, which includes the metering system 110, modular card 115, and digital load controller 127d. In this embodiment, the metering panel system 129b includes (he metering system 110, wherein the metering system 110 includes the modular card 115. The metering system 110 includes the sensor port 114 in communication with the modular card 115, wherein the environmental sense signal S_{EnvSense} flows therebetween. As discussed in more detail above, the environmental sense signal S_{EnvSense} is provided by a sensor, such as the sensors discussed above. For example, the environmental sensor can include one or more of the sensors of FIG. 4, if desired. In this embodiment, rite modular card 115 is connected to the digital load controller 127d so that the signal flows therebetween. More information regarding the digital load controller 127d is provided above.

In this embodiment, the metering system 110 includes the voltage sensor 103a in communication with the modular card so the voltage signal S_{Voltage} flows therebetween. Further, the metering panel system 129b includes the current sensor 103b in communication with the modular card 115 so the current signal S_{Current} flows therebetween. The metering panel system 129b includes the electrical load 104 in communication with the current sensor 103b. The electrical load 104 operates in response to the power signal S_{Power}, wherein the voltage sensor 103a determines the voltage of the power signal S_{Power}, and the current sensor 103b determines the current of the power signal S_{Power}. It should be noted that the power signal S_{Power} flows through the voltage sensor 103a and current sensor 103b. Further, it should be noted that the electrical load 104 of FIG. 10 can be any of the electrical loads mentioned above with FIG. 3.

In this embodiment, the metering system 110 includes the energy gateway processor server 116 in communication with the modular card 115, and the communication network 118 in communication with the energy gateway processor server 116. It should be noted that, in this embodiment, the sensor port 114. modular card 115, voltage sensor 103a, and current sensor 103b can be carried by a circuit board, such as circuit board 107 in FIGS. 9a and 9b. The metering panel system 129b includes the cloud data analytics network 120 in communication with the communication network 118 through the communication link 133. As mentioned above, the user can access the cloud data analytics network 120 in many different ways, such as by using a computer, smart phone, and tablet. In operation, the data packet S_{DataPacket}, can include voltage and current date corresponding to the operation of the electrical load 104. More information regarding the voltage and current data is provided in more detail above.

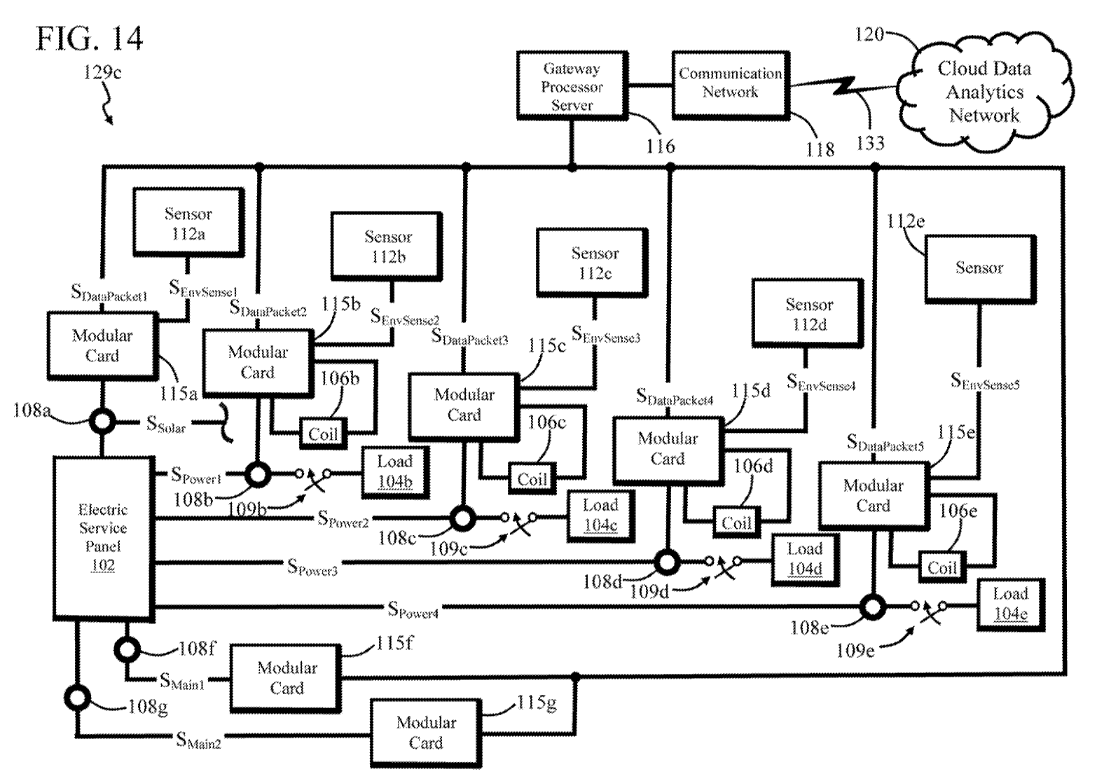

FIG. 14 is a block diagram of one embodiment of a metering panel system 129c. In this embodiment, the metering panel system 129e includes an electric service panel 102, which is of the type typically included with a building. The electric service panel 102 is typically connected to an electrical main, such as the electrical main provided by a utility company. In this embodiment, the metering service system 129c includes a modular card 115f, which is connected to the electric service panel 102 through a current transformer 108f. Further, the metering service system 129c includes a modular card 115g, which is connected to the electric service panel 102 through a current transformer 108g. It should be noted that the modular cards 115f and 115g are associated with electrical mains signals S_{Main1} and S_{Main2} respectively.

The metering panel system 129c includes a modular card 115a, which is connected to the electric service panel 102 through a current transformer 108a. It should be noted that the current transformer 108a can receive a solar power signal, such as S_{Solar}, from a solar power source. The solar power source can be of many different types, such as a solar panel. In general, the solar power source can include one or more solar panels. The metering panel system 129c includes a sensor 112a, which is connected to the modular card 115a. An environmental sense signal S_{EnvSense1} flows between the modular card 115a and sensor 112a.

The metering panel system 129c includes the gateway processor service 116, which is connected to the modular card 115a. The metering panel system 129c includes the communication network 118. which is connected to the gateway processor service 116. The metering panel system 129c includes the cloud data analytics network 120, which is connected to the communications network 118 through the communication line 133. It should be noted that the modular cards 115f and 115g are connected to the gateway processor service 116.

The metering panel system 129c includes a plurality of loads connected to the electric service panel 102. In general, the metering panel system 129c includes one or more loads connected to the electric service panel 102. In this embodiment, the metering panel system 129c includes a load 104b connected to the electric service panel 102 through a current transformer 108b and a relay 109b. The electric service panel 102 provides a power signal S_{Power1} when the relay 109b is closed, and the electric service panel 102 does not provide the power signal S_{Power1} when the relay 109b is open. The metering panel system 129c includes a modular card 115b which is connected to the current transformer 108b and gateway processor server 116. The metering panel system 129c includes a sensor 112b, which is connected to the modular card 115a. An environmental sense signal S_{EnvSense2} flows between the modular card 115b and sensor 112b. The metering panel system 129c includes a coil 106b, which is coupled to die modular card 115b.

In this embodiment, the metering panel system 129c includes a load 104c connected to the electric service panel 102 through a current transformer 108c and a relay 109c. The electric service panel 102 provides a power signal S_{Power2} when the relay 109c is closed, and the electric service panel 102 does not provide the power signal S_{Power2} when the relay 109c is open. The metering panel system 129c includes a modular card 115c which is connected to the current transformer 108e and gateway processor server 116. The metering panel system 129c includes a sensor 112c. which is connected to the modular card 115c. An environmental sense signal S_{EnvSense3} flows between the modular card 115c and sensor 112c. The metering panel system 129e includes a coil 106c, which is coupled to the modular card 115c.

In this embodiment, the metering panel system 129c includes a load 104d connected to the electric service panel 102 through a current transformer 108d and a relay 109d. The electric service panel 102 provides a power signal S_{Power3} when the relay 109d is closed, and the electric service panel 102 does not provide the power signal S_{Power3} when the relay 109d is open. The metering panel system 129c includes a modular card 115d which is connected to the current transformer 108d and gateway processor server 116. The metering panel system 129c includes a sensor 112d, which is connected to the modular card 115d. An environmental sense signal S_{EnvSense4} flows between the modular card 115d and sensor 112d. The metering panel system 129c includes a coil 106d, which is coupled to the modular card 115d.

In this embodiment, the metering panel system 129c includes a load 104e connected to the electric service panel 102 through a current transformer 108e and a relay 109c. The electric service panel 102 provides a power signal S_{Power4} when the relay 109e is closed, and the electric service panel 102 does not provide the power signal S_{Power4} when the relay 109e is open. The metering panel system 129c includes a modular card 115e which is connected to the current transformer 108e and gateway processor server 116. The metering panel system 129c includes a sensor 112e, which is connected to the modular card 115c. An environmental sense signal S_{EnvSense5} flows between the modular card 115e and sensor 112e. The metering panel system 129c includes a coil 106e, which is coupled to the modular card 115e. As mentioned above, the user can access the cloud data analytics network 120 in many different ways, such as by using a computer, smart phone, and tablet.

In operation, the data packet S_{DataPacket1} is flowed to the gateway processor server 116 through the modular card 115a. The data packet S_{DataPacket1} includes information corresponding to the environmental sense signal S_{EnvSense1}. In some embodiments, the data packet S_{DataPacket1} includes information corresponding to the solar power signal S_{Solar}. The data packet S_{DataPacket1} is provided to the communication network 118 from the gateway processor server 116. The data packet S_{DataPacket1} is provided to the cloud data analytics network 120 through the communication network 118 and communication link 133. The user can view the information of the data packet S_{DataPacket1} using the computer 123, if desired. In particular, the user can view the information corresponding to the environmental sense signal S_{EnvSense1}. In this way, the energy management system 100c monitors the operation of the solar panel and sensor 112a.

In operation, the data packet S_{DataPacket2} is flowed to the gateway processor server 116 through the modular card 115b. The data packet S_{DataPacket2} includes information corresponding to the power signal S_{Power1} and environmental sense signal S_{EnvSense2}. In some embodiments, the data packet SDataPacket2 includes information corresponding to a current signal S_{Coil1} which flows through the coil 106b. The data packet S_{DataPacket2} is provided to the communication network 118 from the gateway processor server 116. The data packet S_{DataPacket2} is provided to the cloud data analytics network 120 through the communication network 118 and communication link 133. The user can view the information of the data packet S_{DataPacket2} using the computer 123, if desired. In particular, the user can view the information corresponding to the power signal S_{Power1}, current signal S_{Coil1} and environmental sense signal S_{EnvSense2}. It should be noted that the power signal S_{Power1} and current signal S_{Coil1} correspond to the power and current being used by the load 104b. In this way, the energy management system 100c adjusts and/or monitors the operation of the load 104b using two-way communication.

In operation, the data packet S_{DataPacket3} is flowed to the gateway processor server 116 through the modular card 115c. The data packet S_{DataPacket3} includes information corresponding to the power signal S_{Power2} and environmental sense signal S_{EnvSense3}. In some embodiments, the data packet S_{DataPacket3} includes information corresponding to a current signal S_{Coil2} which flows through the coil 106c. The data packet S_{DataPacket3} is provided to the communication network 118 from the gateway processor server 116. The data packet S_{DataPacket3} is provided to the cloud data analytics network 120 through the communication network 118 and communication link 133. The user can view the information of the data packet S_{DataPacket3} using the computer 123, if desired. In particular, the user can view the information corresponding to the power signal S_{Power2}, current signal S_{Coil2}, and environmental sense signal S_{EnvSense}. It should be noted that the power signal S_{Power2} and current signal S_{Coil2} correspond to the power and current being used by the loud 104c. In this way, the energy management system 100c monitors and/or adjusts the operation of the load 104c using two-way communication.

In operation, the data packet S_{DataPacket4} is flowed to the gateway processor server 116 through the modular card 115d. The data packet S_{DataPacket4} includes information corresponding to the power signal S_{Power3} and environmental sense signal S_{EnvSense4} to some embodiments, the data packet S_{DataPacket4} includes information corresponding to a current signal S_{Coil3} which flows through the coil 106d. The data packet S_{DataPacket4} is provided to the communication network 118 from the gateway processor server 116. The data packet S_{DataPacket4} is provided to the cloud data analytics network 120 through the communication network 118 and communication link 133. The user can view the information of the data packet S_{DataPacket3} using the computer 123, if desired. In particular, the user can view the information corresponding to the power signal S_{Power3}, current signal S_{Coil3}, and environmental sense signal S_{EnvSense4}. It should be noted that the power signal S_{Power3} and current signal S_{Coil3} correspond to the power and current being used by the load 104d. In this way, the energy management system 100c monitors and/or adjusts the operation of the load 104d using two-way communication.

In operation, the data packet S_{DataPacket5} is flowed to the gateway processor server 116 through the modular card 115e. The data packet S_{DataPacket5} includes information corresponding to the power signal S_{Power4} and environmental sense signal S_{EnvSense5} to some embodiments, the data packet includes information corresponding to a current signal S_{Coil4} which flows through the coil 106e. The data packet S_{DataPacket5} is provided to the communication network 118 from the gateway processor server 116. The data packet S_{DataPacket5} is provided to the cloud data analytics network 120 through the communication network 118 and communication link 133. The user can view the information of the data packet S_{DataPacket5} using the computer 123, if desired. In particular, the user can view the information corresponding to the power signal S_{Power4}, current signal S_{Coil4}, and environmental sense signal S_{EnvSense}. It should be noted that the power signal S_{Power4} and current signal S_{Coil4} correspond to the power and current being used by the load 104c. In this way. the energy management system 100c monitors and/or adjusts the operation of the load 104e using two-way communication.

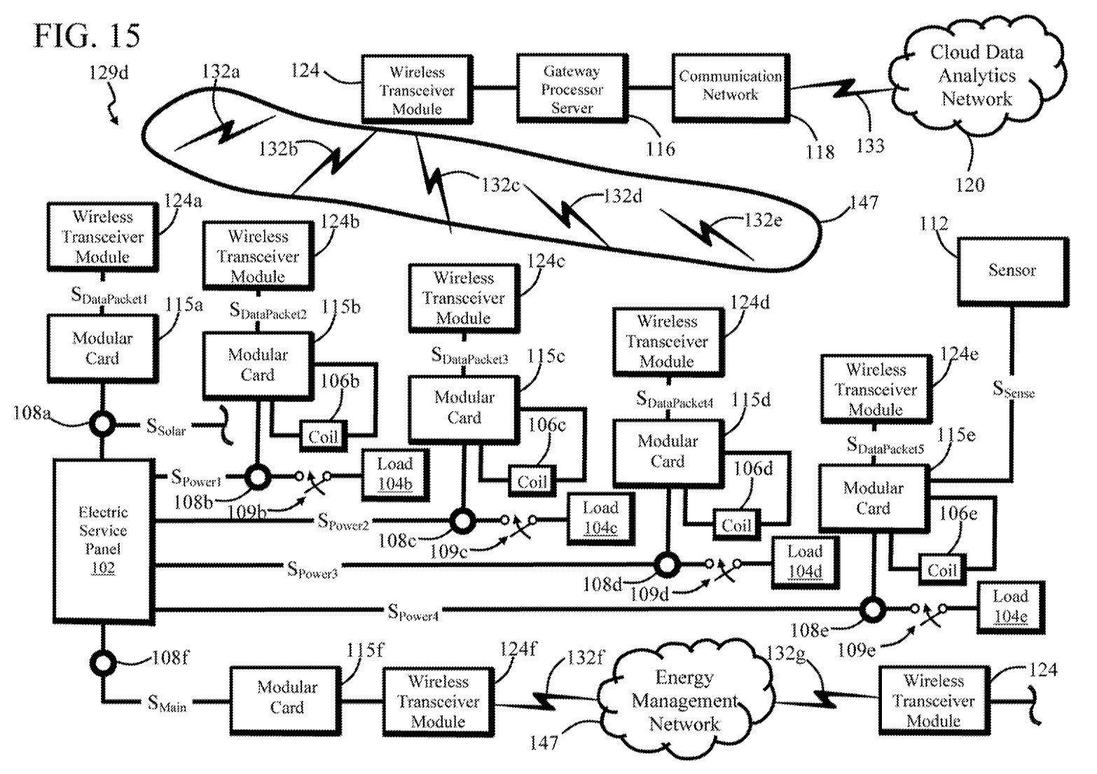

FIG. 15 is a block diagram of one embodiment of a metering panel system 129d. In this embodiment, the metering panel system 129d includes the electric service panel 102, which is of the type typically included with a building. The electric service panel 102 is typically connected to an electrical main, such as the electrical main provided by a utility company. In this embodiment, the metering service system 129d includes the modular card 115f, which is connected to the electric service panel 102 through the current transformer 108f. It should be noted that the modular cards 115f is associated with electrical mains signal S_{Main}. The modular card 115f is connected to the wireless transceiver module 124f, and the wireless transceiver module 124f is in communication with the energy management data packet network 147 through a wireless link 132f. The energy management data packet network 147 is in communication with the wireless transceiver module 124, and the wireless transceiver module 124 is in communication with the gateway processor server 116. communication network 118, and cloud data analytics network 120. as described herein.

The metering panel system 129d includes the modular card 115a, which is connected to the electric service panel 102 through the current transformer 108a. It should be noted that the current transformer 108a can receive the solar power signal, such as S_{Solar}, from a solar power source. The solar power source can be of many different types, such as a solar panel. In general, the solar power source can include one or more solar panels.

The metering panel system 129d includes the gateway processor service 116, which is connected to the modular card 115a. The metering panel system 129d includes the communication network 118, which is connected to the gateway processor service 116. The metering panel system 129d includes the cloud data analytics network 120, which is connected to the communications network 118 through the communication line 133.

The metering panel system 129d includes a plurality of loads connected to the electric service panel 102. In general, the metering panel system 129d includes one or more loads connected to the electric service panel 102. In this embodiment, the metering panel system 129d includes the load 104b connected to the electric service panel 102 through the current transformer 108b and the relay 109b. The electric service panel 102 provides the power signal S_{Power1} when the relay 109b is closed, and the electric service panel 102 does not provide the power signal S_{Power1} when the relay 109b is open. The metering panel system 129d includes the modular card 115b which is connected to the current transformer 108b and coil 106b. The metering panel system 129d includes the wireless transceiver module 124b which is in communication with the modular card 115b. The wireless transceiver module 124b is in communication with the wireless transceiver module 124 through the energy management data packet network 147, wherein a communication link 132b is established therebetween.

In this embodiment, the metering panel system 129d includes the load 104c connected to the electric service panel 102 through the current transformer 108c and the relay 109c. The electric service panel 102 provides the power signal S_{Power2} when the relay 109c is closed, and the electric service panel 102 does not provide the power signal S_{Power2} when the relay 109c is open. The metering panel system 129d includes the modular card 115c which is connected to the current transformer 108c and coil 106c. The metering panel system 129d includes the wireless transceiver module 124c which is in communication with the modular card 115c. The wireless transceiver module 124b is in communication with the wireless transceiver module 124 through the energy management data packet network 147, wherein a communication link 132c is established therebetween.

In this embodiment, the metering panel system 129d includes the load 104d connected to the electric service panel 102 through the current transformer 108d and the relay 109d. The electric service panel 102 provides the power signal S_{Power3} when the relay 109d is closed, and the electric service panel 102 does not provide the power signal S_{Power3} when the relay 109d is open. The metering panel system 129d includes the modular card 115d which is connected to the current transformer 108d and coil 106d. The metering panel system 129d includes the wireless transceiver module 124d which is in communication with the modular card 115d. The wireless transceiver module 124b is in communication with the wireless transceiver module 124 through the energy management data packet network 147, wherein a communication link 132d is established therebetween.

In this embodiment, the metering panel system 129d includes the load 104e connected to the electric service panel 102 through the current transformer 108e and the relay 109e. The electric service panel 102 provides the power signal S_{Power4} when the relay 109e is closed, and the electric service panel 102 does not provide the power signal S_{Power4} when the relay 109e is open. The metering panel system 129d includes the modular card 115e which is connected to the current transformer 108e and coil 106e. In this embodiment, the metering panel system 129d includes a sensor 112, which is in communication with the modular card 115e so that the environmental sense signal S_{Sense} flows therebetween. The metering panel system 129e includes the wireless transceiver module 124e which is in communication with the modular card 115e. The wireless transceiver module 124b is in communication with the wireless transceiver module 124 through the energy management data packet network 147, wherein a communication link 132e is established therebetween.

In operation, the data packet S_{DataPacket1} flowed between the wireless transceiver modules 124 and 124a through the energy management data packet network 147. The data packet S_{DataPacket1} includes information corresponding to the solar power signal S_{Solar}. The data packet S_{DataPacket1} is provided to the gateway processor server 116 and communication network 118. The data packet S_{DataPacket1} is provided to the cloud data analytics network 120 through the communication network 118 and communication link 133. The user can view the information of the data packet S_{DataPacket1} using the computer 123, if desired. In particular, the user can view the information corresponding to the solar power signal S_{Solar}. In this way, the energy management system 100c monitors the operation of the solar panel.

In operation, the data packet S_{DataPacket2} is flowed between the wireless transceiver modules 124 and 124b through the energy management data packet network 147. The data packet S_{DataPacket2} includes information corresponding to the power signal S_{Power1}. The data packet S_{DataPacket2} is provided to the gateway processor server 116 and communication network 118. The data packet S_{DataPacket2} is provided to the cloud data analytics network 120 through the communication network 118 and communication link 133. The user can view the information of the data packet S_{DataPacket2} using the computer 123, if desired. In particular, the user can view the information corresponding to the power signal S_{Power1}. In this way, the energy management system 100c monitors and/or adjusts the operation of the load 104b using two-way communication.

In operation, the data packet S_{DataPacket3} flowed between the wireless transceiver modules 124 and 124c through the energy management data packet network 147. The data packet S_{DataPacket3} includes information corresponding to the power signal S_{Power2}. The data packet S_{DataPacket3} is provided to the gateway processor server 116 and communication network 118. The data packet S_{DataPacket3} is provided to the cloud data analytics network 120 through the communication network 118 and communication link 133. The user can view the information of the data packet S_{DataPacket3} using the computer 123, if desired. In particular, the user can view the information corresponding to the power signal S_{Power2}. In this way, the energy management system 100c monitors and/or adjusts the operation of the load 104c using two-way communication.

In operation, the data packet S_{DataPacket4} is flowed between the wireless transceiver modules 124 and 124d through the energy management data packet network 147. The data packet S_{DataPacket3} includes information corresponding to the power signal S_{Power3}. The data packet S_{DataPacket4} is provided to the gateway processor server 116 and communication network 118. The data packet S_{DataPacket4} is provided to the cloud data analytics network 120 through the communication network 118 and communication link 133. The user can view the information of the data packet S_{DataPacket4} using the computer 123, if desired. In particular, the user can view the information corresponding to the power signal S_{Power3}. In this way, the energy management system 100c monitors and/or adjusts the operation of the load 104d using two-way communication.

In operation, the data packet S_{DataPacket5} flowed between the wireless transceiver modules 124 and 124e through the energy management data packet network 147. The data packet S_{DataPacket5} includes information corresponding to the power signal S_{Power4} and environmental sense signal S_{Sense}. The data packet S_{DataPacket5} is provided to the gateway processor server 116 and communication network 118. The data packet S_{DataPacket5} is provided to the cloud data analytics network 120 through the communication network 118 and communication link 133. The user can view the information of the data packet S_{DataPacket5} using the computer 123, if desired. In particular, the user can view the information corresponding to the power signal S_{Power4} and the environmental sense signal S_{Sense}. In this way, the energy management system 100c monitors and/or adjusts the operation of the load 104e and the sensor 112 using two-way communication.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. A system, comprising:
a metering system: and
a load sensor which provides the metering system with a performance parameter corresponding to the operation of an electrical load:
wherein the metering system provides a data signal to an energy management data packet network, wherein the data signal includes information regarding the performance parameter.

2. The system of claim 1, further including a cloud data analytics network in communication with the energy management data packet network,

3. The system of claim 2, wherein the cloud data analytics network provides a graph which corresponds to the data signal.

4. The system of claim 1, further including an environmental sensor which provides information corresponding to the environment proximate to the electrical load.

5. The system of claim 4, wherein the information provided by the environmental sensor is included with the data signal.

6. The system of claim 1, further including a computer in communication with the metering system, the computer providing a control signal which controls the operation of the electrical load.

7. The system of claim 7, wherein the data signal is adjusted in response to the metering system receiving the control signal.

8. A system, comprising:
a modular card, which receives a load sense signal and environmental sense signal, and provides a data packet which corresponds to the load sense signal and environmental sense signals: and
wherein the modular card controls the operation of an electrical load in response to receiving a control signal, the control signal being chosen in response to the data packet.

9. The system of claim 8, further including an environmental sensor, which provides the environmental sense signal to the modular card.

10. The system of claim 8, further including a load sensor, which provides the load sense signal to the modular card.

11. The system of claim 8, wherein the data packet includes the load sense signal includes information regarding a performance parameter of the electrical load.

12. The system of claim 11, wherein operation of the electrical load is adjusted in response to the modular card receiving the control signal.

13. The system of claim 12, wherein the control signal corresponds to a control signal data packet, includes time and date information.

14. A system, comprising:
a first metering system;
a first load sensor which provides the first metering system with a first performance parameter corresponding to the operation of a first electrical load:
wherein the first metering system provides a first data packet to an energy management data packet network, wherein the first data packet includes information regarding the first performance parameter;
a second metering system; and
a second load sensor which provides the second metering system with a second performance parameter corresponding to the operation of a second electrical load;
wherein the second metering system provides a second data packet to the energy management data packet network, wherein the second data packet includes information regarding the second performance parameter.

15. The system of claim 14, further including a cloud data analytics network in communication with the energy management data packet network.

16. The system of claim 14, wherein the operation of the first and second electrical loads is adjusted in response to the corresponding first and second metering systems receiving first and second control data packets, respectively.

17. The system of claim 16, further including a first environmental sensor, which provides a first environmental sense signal to the first metering system.

18. The system of claim 17, further including a second environmental sensor, which provides a second environmental sense signal to the second metering system.

19. The system of claim 18. wherein the first and second environmental sense signals are included with the first and second data packets, respectively.

20. The system of claim 19, wherein the first and second control data packets are determined in response to the first and second environmental sense signals, respectively.
